(19) United States
(12) Patent Application Publication
(10) Pub. No.: US 2026/0301505 A1
(43) Pub. Date: Oct. 1, 2026

(54) LAYERED STENCIL LIGHTING SYSTEMS FOR ELECTRONIC GAMING MACHINES

(71) Applicant: Aristocrat Technologies, Inc., Las Vegas, NV (US)

(72) Inventors: Shanon Nishimura, Las Vegas, NV (US); David Morales, Las Vegas, NV (US); Mehmet Oymen, Castle Hill (AU); Ari Da Silva, Kirrawee (AU); Kamaldeep Munjral, Quakers Hill (AU); Le Anh Nguyen, Fairfield (AU)

(21) Appl. No.: 19/094,535

(22) Filed: Mar. 28, 2025

(51) Int. Cl. G07F 17/32

(52) U.S. Cl. CPC G07F 17/3211

(57) ABSTRACT

Layered stencil lightbox systems are provided. Some systems have a first stencil layer having a plurality of first through-holes extending from a first front surface to a first back surface, a second stencil layer having a plurality of second through-holes extending from a second front surface to a second back surface, a third stencil layer, a first plurality of light emitting diodes (LEDs) proximate to a first edge of the first stencil layer and a second edge of the second stencil layer, and configured to emit light between the first and second stencil layers, and a second plurality of LEDs proximate to the second edge of the second stencil layer, and configured to emit light between the second and third stencil layers. The second stencil layer is positioned between, and offset from, the first and third stencil layers, and each first through-hole at least partially overlaps each respective second through-hole.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Electronic gaming machines are complex devices with display devices and are often housed within cabinets having various lights and lighting assemblies.

### SUMMARY

Details of one or more implementations of the subject matter described in this specification are set forth in the accompanying drawings and the description below. Other features, aspects, and advantages will become apparent from the description, the drawings, and the claims. The following, non-limiting implementations are considered part of the disclosure; other implementations will be evident from the entirety of this disclosure and the accompanying drawings as well.

In some implementations, a layered stencil lightbox system may be provided. The system may have a first stencil layer arranged along a first axis and having a first front surface, a first back surface offset from the first front surface, and a plurality of first through-holes extending from the first front surface to the first back surface and arrayed along the first axis, a second stencil layer arranged along a second axis parallel to the first axis, and having a second front surface, a second back surface offset from the second front surface, and a plurality of second through-holes extending from the second front surface to the second back surface and arrayed along the second axis, a third stencil layer arranged along a third axis parallel to the first axis, and having a third front surface that faces the second back surface of the second stencil layer, and a third back surface offset from the third front surface, a first plurality of light emitting diodes (LEDs) positioned proximate to a first edge of the first stencil layer and a second edge of the second stencil layer, and configured to emit light between the first stencil layer and the second stencil layer, and a second plurality of LEDs positioned proximate to the second edge of the second stencil layer, and configured to emit light between the second stencil layer and the third stencil layer. The second stencil layer may be positioned between the first stencil layer and the third stencil layer such that the second front surface faces the first back surface of the first stencil layer, and the second back surface faces the third front surface of the third stencil layer, and offset from the first stencil layer and the third stencil layer in a direction perpendicular to the first axis, and each first through-hole may at least partially overlap each respective second through-hole.

In some implementations, the system may further include a first transparent layer of material interposed between the first stencil layer and the second stencil layer, and a second transparent layer of material interposed between the second stencil layer and the third stencil layer. The first plurality of LEDs may be arranged adjacent to a first edge of the first transparent layer of material and configured to emit light into the first transparent layer of material, and the second plurality of LEDs may be arranged adjacent to a first edge of the second transparent layer of material and configured to emit light into the first transparent layer of material.

In some implementations, the first transparent layer of material may have a first back surface with a first portion that is at least partially opaque and with a plurality of first windows that each provide a line of sight through the first back surface, the second transparent layer of material may have a second back surface with a second portion that is at least partially opaque and with a plurality of second windows that each provide a line of sight through the second back surface, each first window may at least partially overlap with a respective first through-hole, each first through-hole may at least partially overlap with a respective second window, and each second window may at least partially overlap with a respective second through-hole.

In some such implementations, the first portion and the second portion may have texturing.

In some such implementations, each first through-hole and a respective first window, respective second through-hole, and respective second window may be arranged along a respective stencil axis perpendicular to the first axis.

In some implementations, the first transparent layer of material may have a third window defined by a third boundary and one or more third features extending along the third boundary and extending at least partially through a thickness of the first transparent layer of material, and the second transparent layer of material may have a fourth window defined by a fourth boundary and one or more fourth features extending along the fourth boundary and extending at least partially through a thickness of the second transparent layer of material.

In some such implementations, the one or more third features may be a plurality of holes or one or more channels, and the one or more fourth features may be a plurality of holes or one or more channels.

In some implementations, the first stencil layer may be coupled to the first transparent layer of material, and the second stencil layer may be coupled to the second transparent layer of material.

In some implementations, each first through-hole may have a first area, and each second through-hole may have a second area that is smaller than the first area.

In some implementations, each first through-hole may define a first shape, and each second through-hole may define a second shape that is different than the first shape and smaller than the first shape.

In some implementations, each first through-hole may define a first shape, and each second through-hole may define a second shape that is oriented at an angular offset from the first shape.

In some implementations, the system may further include a fourth stencil layer arranged along a fourth axis parallel to the first axis, and having a fourth front surface and a fourth back surface offset from the fourth front surface, and a third plurality of LEDs positioned proximate to a third edge of the third stencil layer and configured to emit light between the third stencil layer and the fourth stencil layer. The third stencil layer may further have a plurality of third through-holes extending from the third front surface to the third back surface and arrayed along the third axis, the third stencil layer may be positioned between the second stencil layer and the fourth stencil layer such that the third front surface faces the second back surface of the second stencil layer, and the third back surface faces the fourth front surface of the fourth stencil layer, and offset from the second stencil layer and the fourth stencil layer in the direction perpendicular to the first axis, each first through-hole may at least partially overlap each respective third through-hole, and each second through-hole may at least partially overlap each respective third through-hole.

In some such implementations, each first through-hole may have a first area, each second through-hole may have a second area that is smaller than the first area, and each third through-hole may have a third area that is smaller than the second area.

In some implementations, the first plurality of LEDs may be positioned outside a first gap between the first stencil layer and the second stencil layer, and the second plurality of LEDs may be positioned outside a second gap between the second stencil layer and the third stencil layer.

In some implementations, the third stencil layer may be without through-holes and may have a plurality of shapes in a surface of the third stencil layer that are arrayed along the third axis, each first through-hole may at least partially overlap each respective shape, and each second through-hole may at least partially overlap each shape.

In some implementations, the system may further include a first sidewall adjacent to the first edge of the first stencil layer, the second edge of the second stencil layer, and the third stencil layer, and a second sidewall adjacent to a third edge of the first stencil layer opposite the first edge, a fourth edge of the second stencil layer opposite the second edge, and the third stencil layer. The first plurality of LEDs and the second plurality of LEDs may be coupled to the first sidewall, and the first stencil layer and the second stencil layer may be interposed between the first sidewall and the second sidewall.

In some implementations, the first axis, the second axis, and the third axis may be linear.

In some implementations, the first axis, the second axis, and the third axis may be nonlinear, and the first stencil layer, the second stencil layer, and the third stencil layer may be nonplanar or planar.

In some implementations, an electronic gaming machine may be provided. The electronic gaming machine may have a cabinet defining an internal compartment, one or more display devices connected to the cabinet, and a layered stencil lightbox system positioned on the cabinet and having a first stencil layer arranged along a first axis and having a first front surface, a first back surface offset from the first front surface, and a plurality of first through-holes extending from the first front surface to the first back surface and arrayed along the first axis, a second stencil layer arranged along a second axis parallel to the first axis, and having a second front surface, a second back surface offset from the second front surface, and a plurality of second through-holes extending from the second front surface to the second back surface and arrayed along the second axis, a third stencil layer arranged along a third axis parallel to the first axis, and having a third front surface that faces the second back surface of the second stencil layer, and a third back surface offset from the third front surface, a first plurality of light emitting diodes (LEDs) positioned proximate to a first edge of the first stencil layer and a second edge of the second stencil layer, and configured to emit light between the first stencil layer and the second stencil layer, and a second plurality of LEDs positioned proximate to the second edge of the second stencil layer, and configured to emit light between the second stencil layer and the third stencil layer. The second stencil layer may be positioned between the first stencil layer and the third stencil layer such that the second front surface faces the first back surface of the first stencil layer, and the second back surface faces the third front surface of the third stencil layer, and offset from the first stencil layer and the third stencil layer in a direction perpendicular to the first axis, and each first through-hole may at least partially overlap each respective second through-hole.

In some implementations, a method is provided. The method may include emitting light, with a first plurality of light emitting diodes (LEDs), in a first gap between a first stencil layer and a second stencil layer, in which the first stencil layer is arranged along a first axis and has a first front surface, a first back surface offset from the first front surface, and a plurality of first through-holes extending from the first front surface to the first back surface and arrayed along the first axis, the second stencil layer is arranged along a second axis parallel to the first axis, and has a second front surface, a second back surface offset from the second front surface, and a plurality of second through-holes extending from the second front surface to the second back surface and arrayed along the second axis, the first plurality of LEDs is positioned proximate to a first edge of the first stencil layer and a second edge of the second stencil layer, and configured to emit light between the first stencil layer and the second stencil layer, and emitting light, with a second plurality of LEDs, in a second gap between the second stencil layer and a third stencil layer while the first plurality of LEDs are not illuminating the first gap, in which the third stencil layer is arranged along a third axis parallel to the first axis, and having a third front surface that faces the second back surface of the second stencil layer, and a third back surface offset from the third front surface, the second stencil layer is positioned between the first stencil layer and the third stencil layer such that the second front surface faces the first back surface of the first stencil layer, and the second back surface faces the third front surface of the third stencil layer, and offset from the first stencil layer and the third stencil layer in a direction perpendicular to the first axis, each first through-hole at least partially overlaps each respective second through-hole, and the second plurality of LEDs is positioned proximate to the second edge of the second stencil layer, and configured to emit light between the second stencil layer and the third stencil layer.

Additional aspects will be set forth in the detailed description which follows, and, in part, will be apparent from the disclosure, or may be learned by practice of the disclosed embodiments and/or the claimed subject matter.

The foregoing general description and the following detailed description are illustrative and explanatory and are intended to provide further explanation of the claimed subject matter.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts an off-angle view of a portion of a layered stencil lightbox system, according to various implementations.

FIG. 5 depicts an off-angle exploded view of a portion of the layered stencil lightbox assembly of FIG. 4.

FIG. 6 depicts a front view of the system of FIG. 4.

FIG. 7 depicts a plan view of the first, second, and third stencil layers of FIG. 4.

FIG. 8 depicts a top view of the system of FIG. 4.

FIGS. 9A to 9D depict a front view of the system of FIG. 4 with various illustrated illuminations of the gaps between stencil layers.

FIG. 10 depicts a first example illumination sequence.

FIGS. 11A and 11B depict plan views of portions of two stacked stencil layers.

FIG. 12 depicts a top view of another system.

FIG. 13 depicts a front view of a first example curved stencil layer.

FIG. 14 depicts a side view of two curved stencil layers and a plurality of LEDs.

FIG. 15 depicts an example electronic gaming machine with a layered stencil lightbox system.

FIG. 16 depicts an off-angle exploded view of a portion of another layered stencil lightbox assembly.

FIG. 17 depicts an off-angle view of the portion of the assembly of FIG. 16.

FIG. 18 depicts an off-angle exploded view of a portion of yet another layered stencil lightbox assembly.

FIG. 19 depicts an off-angle exploded view of a portion of another layered stencil lightbox assembly.

FIG. 20 depicts a cross-sectional top view of the system of FIG. 16.

FIG. 21 depicts a cross-sectional top view of the system of FIG. 19.

FIG. 22A depicts a plan view of a portion of a transparent layer of material having a window defined by one or more features.

FIG. 22B depicts an off-angle view of the portion of the transparent layer of material of FIG. 22A.

FIG. 22C depicts another configuration of FIG. 22A.

FIG. 22D depicts another configuration of FIG. 22B.

FIG. 22E depicts the assembly of FIG. 21 in another configuration.

FIG. 23 depicts an off-angle view of another transparent layer of material.

FIG. 24 depicts an off-angle view of yet another transparent layer of material.

The Figures are provided for the purpose of providing examples and clarity regarding various aspects of this disclosure and are not intended to be limiting.

### DETAILED DESCRIPTION

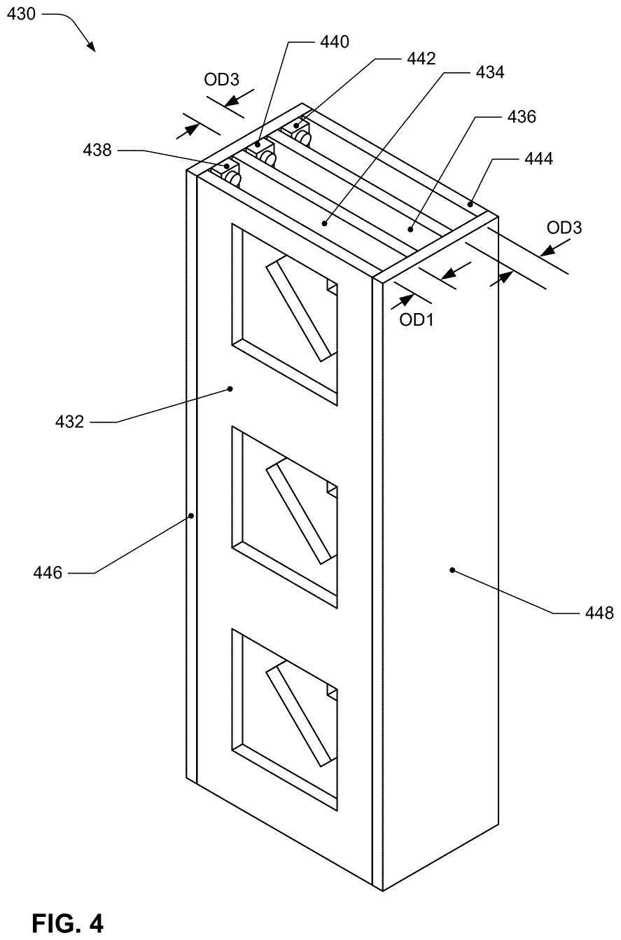

The following discussion provides overall context for electronic gaming machines, some of which may include an enclosure and layered stencil lighting assemblies such as those discussed later herein starting with FIG. 4.

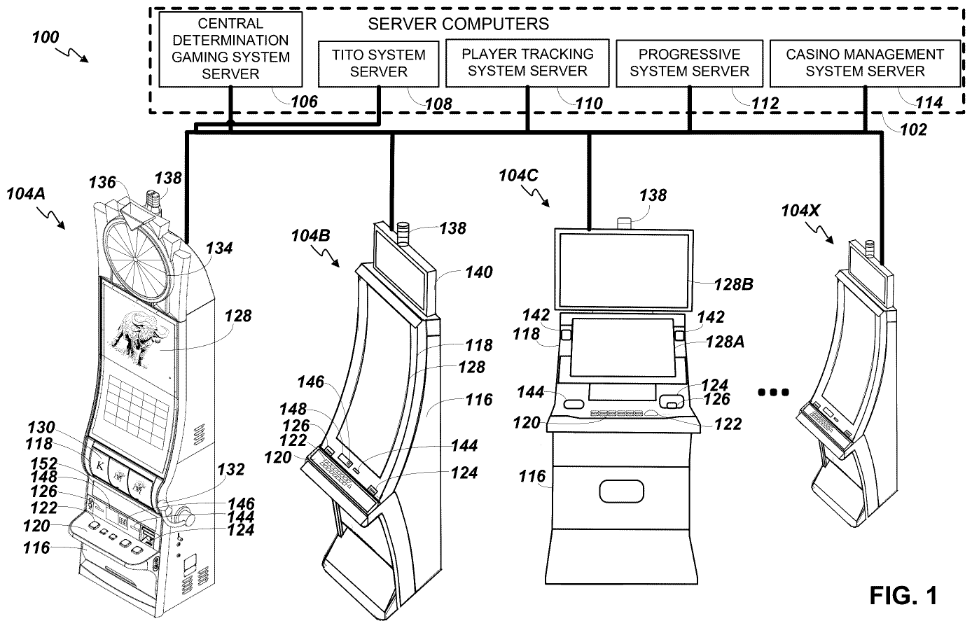

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

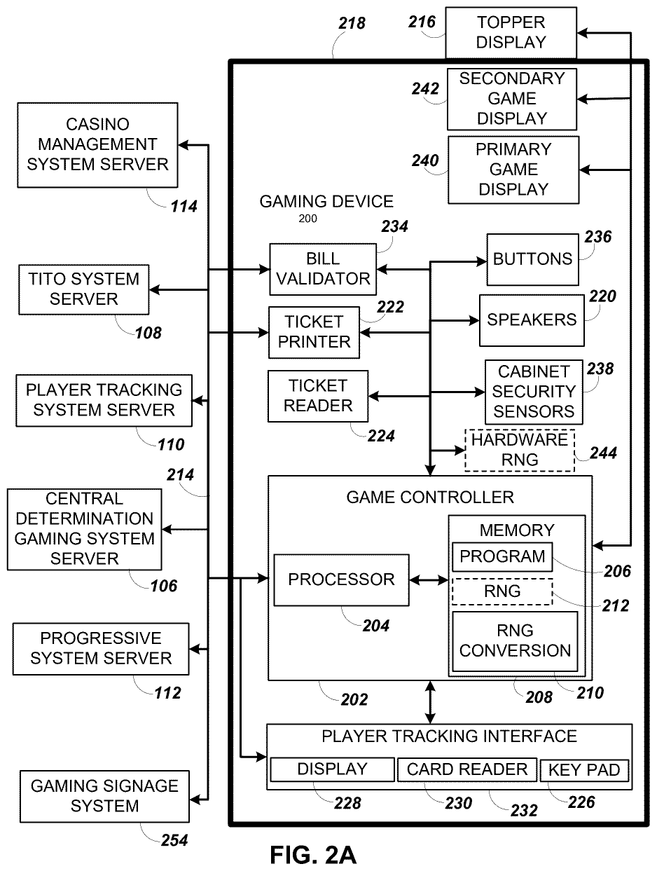

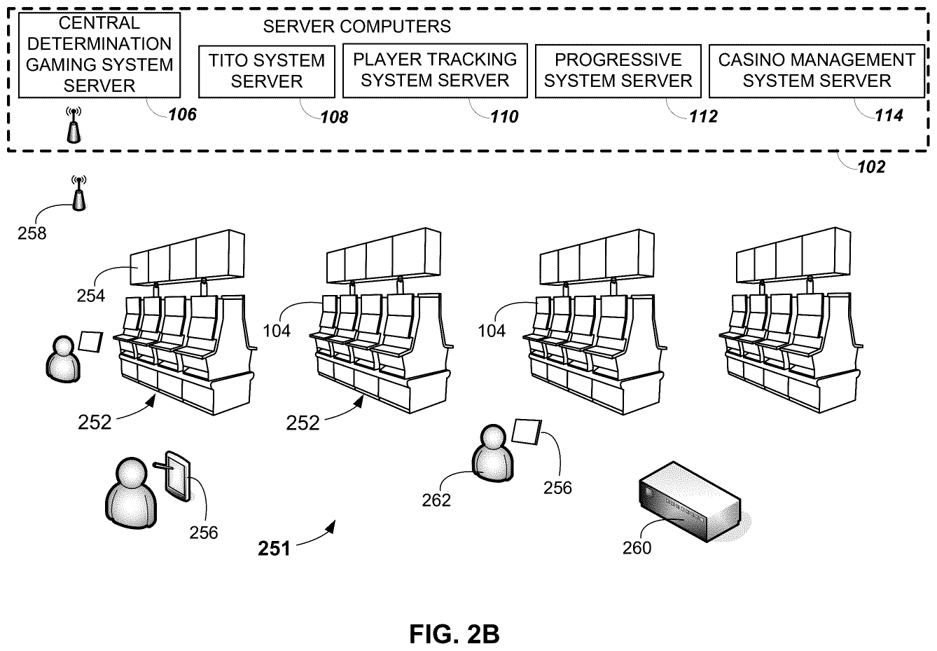

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

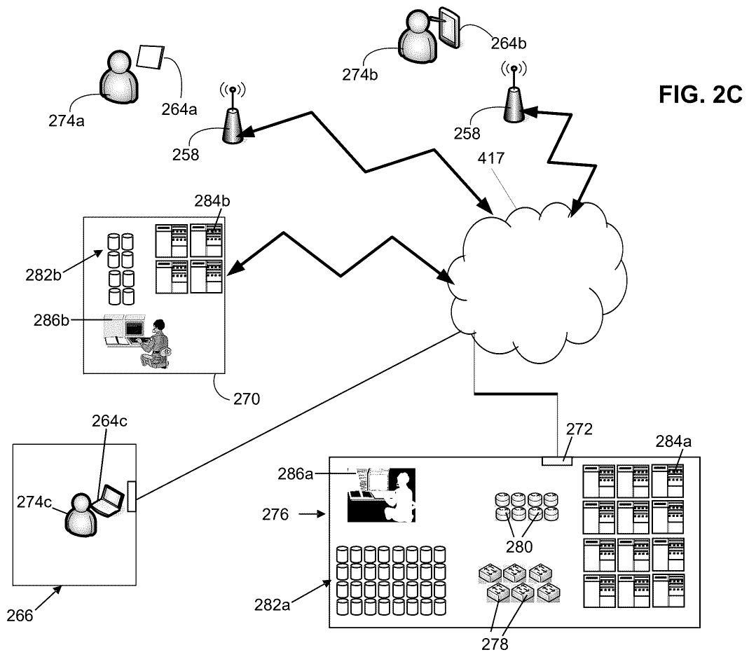

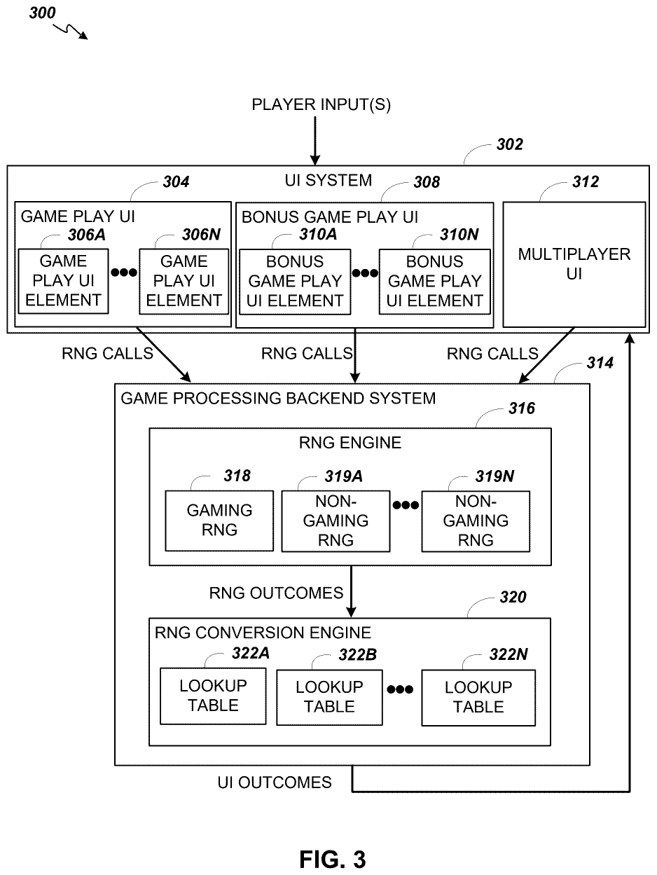

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Electronic gaming machines such as those discussed above may have various lighting systems that serve numerous purposes. For example, the lighting systems may attract potential players to use a particular electronic gaming machine (EGM) by illuminating in different manners, such as flashing or exhibiting sequences, and by providing an attractive appearance. In another example, the lighting systems of EGMs may enhance a user's experience playing or interacting with an EGM. In some instances, the game play or other graphics may be synchronized or coordinated with the EGM's lights and lighting assemblies to provide additional visual stimuli beyond the display devices of the EGMs. However, many challenges exist in providing EGM lights and lighting systems that are aesthetically pleasing. For instance, it is undesirable for users or other persons around the EGMs to have a direct line of sight to the light's emission source, the light emitting diode (LED). This can be challenging for lighting systems that are viewed at multiple angles by users and other persons moving around the EGM. It can also be challenging to provide attractive, dynamic, and varied lighting sequences that use a small amount of power. Many existing EGMs use significant amounts of power to light hundreds or thousands of LEDs and it is desirable to reduce the power consumption of such EGMs. Further, in some instances, existing lighting systems have limited abilities to provide attractive and stimulating lighting sequences beyond illuminating lights in various colors, brightness, and sequences.

Provided herein are new and novel lighting systems that provide numerous advantages, such as the ability to create new and dynamic lighting sequences and visual illusions of moving shapes and images while also conserving power. These lighting systems may be considered layered stencil lightbox systems because they have a plurality of stencil layers that are stacked together, offset from each other, and illuminated from the side of the system. Each stencil layer has a plurality of through-holes having the same or various shapes that overlap with the corresponding, respective through-holes of each stencil layer underneath. These through-holes may be considered the “stencils” of each stencil layer. The stencil layers are offset from each other, and a plurality of LEDs is positioned adjacent to the gap between two adjacent layers and configured to illuminate the gap between the two stencil layers. Although the lighting systems are described in the context of EGMs, these lighting systems are applicable to other contexts, such as vending machines and signs.

The arrangement of the stencil layers may be referenced with respect to an observer of the system. The topmost stencil layer may be the stencil layer closest to the observer, and the immediately adjacent stencil layer to the topmost stencil layer may be considered underneath or behind the topmost stencil layer. As described below, the gap between two adjacent stencil layers may be illuminated, and one stencil layer may be considered an upper stencil layer which is closer to the observer than the other stencil layer, which may be considered the lower stencil layer. The through-holes of the upper layer each provide a line of sight, or visibility, through the upper stencil layer to portions of the lower stencil layer, which may include the lower stencil layer's through-holes. Illuminating this gap with light illuminates the front surface of the lower stencil layer. The top stencil layer covers and blocks visibility to the bottom stencil layer except for the top stencil layer's through-holes which provide a line of sight, or visibility, to the bottom stencil layer and, in some instances, other layers underneath the bottom stencil layer. The illuminated front surface of the lower stencil layer is visible through the through-holes of the upper stencil layer, and these through-holes also frame the illuminated front surface of the lower stencil layer in the shape of such through-holes. This configuration is able to create illuminated shapes of the lower stencil layer. By having multiple stencil layers and illuminating the gaps between adjacent stencil layers in various manners, visual effects of shape movement the through-holes of the stencil layers can be created.

The upper stencil layer's plurality of first through-holes is arrayed along the length of the upper stencil layer. In some instances, the lower stencil layer has a plurality of second through-holes that is also arrayed along the length of the lower stencil layer. The first and second through-holes are arranged in an overlapping manner with respect to each other such that each first through-hole is above each second through-hole. Each first through-hole also provides at least partial visibility, or a partial line of sight, to the respective second through-hole behind it and the lower stencil layer. In some instances, the first through-hole may be considered to at least partially overlap the respective second through-hole. In some implementations, each first through-hole is sized larger than the second through-hole.

Although the stencil layers are static and do not move, the multiple stacked stencil layers and pluralities of LEDs can be used create dynamic visual effects, while also conserving energy. For example, the pluralities of LEDs may be illuminated in offset, staggered, or sequential manners which illuminates some of the stencil layers of the lighting assembly and creates dynamic lighting and shape movement.

FIG. 4 depicts an off-angle view of a portion of a layered stencil lightbox system, according to various implementations. This system 430 has a plurality of stencil layers 432, 434, and 436 that are offset, or spaced apart, from each other such that a gap exists between two adjacent layers. In this example, the system has three stencil layers 432, 434, and 436, but in other instances, the system may have two stencil layers, or more than three stencil layers, such as four stencil layers, five stencil layers, or the like. Each stencil layer is arranged along a respective axis and has a plurality of through-holes arrayed along the respective axis and that extend through the respective stencil layer.

The system 430 also has three pluralities of light emitting diodes (LEDs), that are positioned adjacent to the respective gap between two adjacent stencil layers and configured to emit light between the two stencil layers. As can be seen here, a first plurality of LEDs 438 is positioned between the first stencil layer 432 and the second stencil layer 434 and configured to emit light in a first gap between the first and second stencil layers 432 and 434. Similarly, a second plurality of LEDs 440 is positioned between the second stencil layer 434 and the third stencil layer 436 and configured to emit light in a second gap between the second and third stencil layers 434 and 436. A third plurality of LEDs 442 is positioned between the third stencil layer 436 and another layer 444, which in this instance may be a back layer or bottom layer, and configured to emit light in a third gap between the third stencil layer 436 and the back layer 444.

The layered stencil lightbox system 430 may have other components forming outer boundaries of the system, such as sides and a back. In this depicted example, the system 430 has the back layer 444, a first side 446, and a second side 448 opposite the first side 446. The first, second, and third the stencil layers 432, 434, and 436 are interposed between the first and second sides 446 and 448. The pluralities of LEDs may be coupled to one or more of the sides. In system 430, the first plurality of LEDs 438, the second plurality of LEDs 440, and the third plurality of LEDs 442 are all coupled to the first side 446. In some implementations, like illustrated, the multiple pluralities of LEDs are positioned in the area between two adjacent stencil layers. In other implementations, the pluralities of LEDs are positioned proximate to, but offset from, the area between two adjacent layers. This and additional aspects of the LEDs are provided below.

The through-holes of each stencil layer are configured to provide at least partial visibility to one or more stencil layers underneath that stencil layer. This visibility from one stencil layer to a lower stencil layer is further provided when the plurality of LEDs between these two stencil layers is illuminated. This illumination between two stencil layers also creates a visual effect of one or more illuminated shapes of the stencil layers. For example, the through-holes of the upper stencil layer create illuminated shapes of the lower stencil layers as defined by the upper stencil layer's through-holes. When this illumination is provided sequentially between multiple stencil layers, further visual and movement effects can be created with the lightbox systems provided herein. These and other features and configurations are provided below.

In FIG. 4, the first stencil layer 432 may be considered the topmost layer of the system 430. In this disclosure, a topmost stencil layer may be considered the stencil layer which is closest to an observer, also referred to as a viewer, of the system than the other layers of the system. The topmost layer may also be considered the farthest from the back of the system than the other layers. In FIG. 4, stencil layer 432 is the closest to viewers of the system 430 and farthest from the back layer 444. The other stencil layers may be similarly referenced with respect to viewers and the back layer 444, as well as the topmost layer 432. The second stencil layer 434 is seen behind, or beneath, the first stencil layer 432 such that the second stencil layer 434 is closer to the back layer 444 than the first stencil layer 432, and farther from an observer than the first stencil layer 432. For the relative position between the first and second stencil layers, the first stencil layer 432 may be considered the upper stencil layer and the second stencil layer 434 considered the lower stencil layer, respectively.

The third stencil layer 436 is seen behind, or beneath, the first and second stencil layers 432 and 434, and immediately adjacent to the second stencil layer 434, such that the second stencil layer 434 is closer to the back layer 444 than the first stencil layer 432 and the second stencil layer 434, and farther from an observer than the first stencil layer 432 and the second stencil layer 434. For the relative position between the second and third stencil layers, the second stencil layer 434 may be considered the upper stencil layer and the third stencil layer 436 considered the lower stencil layer, respectively. Similarly, for the relative position between the third and back layers, the third stencil layer 436 may be considered the upper stencil layer and the back layer 444 considered the lower stencil layer, respectively.

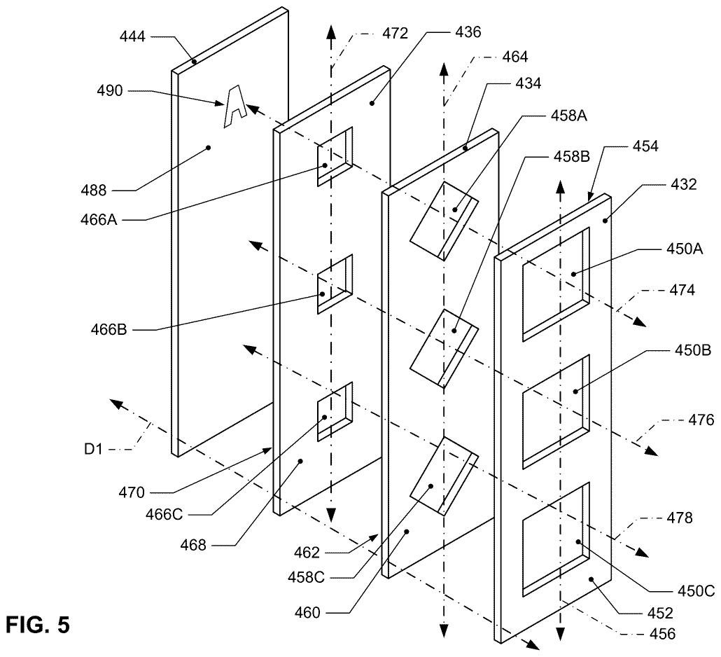

Additional aspects of the stencil layers are illustrated in FIG. 5 which depicts an off-angle exploded view of a portion of the layered stencil lightbox assembly of FIG. 4. Here, the three stencil layers 432, 434, and 436 are shown along with the back layer 444. For clarity, the sides and pluralities of LEDs are omitted. The first stencil layer 432, or the topmost stencil layer, has a plurality of first through-holes 450 which in this example, has three first holes labeled 450A-450C. The first stencil layer 432 has a first front surface 452 and a first back surface 454 opposite and offset from the first front surface 452, and the first through-holes 450A-450C extend fully through the first stencil layer 432 from the first front surface 452 to the first back surface 454. The first stencil layer 432 extends along a first axis 456 and the plurality of first through-holes 450 is arrayed along the first axis 456. As used herein, arrayed may be when the through-holes are arranged in a relatively consistent spatial relationship, spatial pattern, order, from each other along the axis, such as each through-hole being spaced sequentially along the stencil layer axis.

Similarly, the second stencil layer 434 is behind the first stencil layer 432 and has a plurality of second through-holes 458 which in this example, has three second holes labeled 458A-458C. The second stencil layer 434 has a second front surface 460 and a second back surface 462 opposite and offset from the second front surface 460. The second through-holes 458A-458C extend fully through the second stencil layer 434 from the second front surface 460 to the second back surface 462. The second stencil layer 434 extends along a second axis 464 and the plurality of second through-holes 458 is arrayed along the second axis 464. In some implementations, the second stencil layer 434 may also be positioned in the system such that its second axis 464 is parallel to the first axis 456.

For the third stencil layer 436, it is behind both stencil layers 434 and 432, and has a plurality of third through-holes 466 which in this example has three through-holes labeled 466A-466C. The third stencil layer 436 has a third front surface 468 and a third back surface 470 opposite and offset from the third front surface 468, and the third through-holes 466A-466C extend fully through the stencil layer 436 from the third front surface 468 to the third back surface 470. The third stencil layer 436 extends along a third axis 472 and the plurality of third through-holes 466 is arrayed along the third axis 472. In some implementations, the third stencil layer 436 may also be positioned in the system such that its third axis 472 is parallel to the first axis 456.

As can be seen in FIG. 5, the second stencil layer 434 is positioned between the first stencil layer 432 and the third stencil layer 436. The second stencil layer 434 is the lower stencil layer with respect to the first stencil layer 432, and is the upper stencil layer with respect to the third stencil layer 436. The second front surface 460 of the second stencil layer 434 faces the first back surface 454 of the first stencil layer 432, and the second back surface 462 of the second stencil layer 434 faces the third front surface 468 of the third stencil layer 436. These stencil layers 432, 434, and 436 are also offset from each other in a direction perpendicular to the first axis 456, which is labeled D1 in FIG. 5. Referring back to FIG. 4, these offsets are indicated by first stencil layer 432 being offset from the second stencil layer 434 by a first offset distance OD1, the second stencil layer 434 being offset from the third stencil layer 436 by a second offset distance OD2, and the third stencil layer 436 being offset form the back layer 444 by a fourth offset distance OD3.

The pluralities of through-holes for the stencil layers may be configured in various manners. In some implementations, each through-hole of one stencil layer at least partially overlaps with a respective through-hole of the other stencil layers. Referring back to FIG. 5, one first through-hole 450A of the first stencil layer 432 at least partially overlaps with one second through-hole 458A of the second stencil layer 434 and at least partially overlaps with one third through-hole 466A of the third stencil layer 436. Similarly, the one second through-hole 458A at least partially overlaps with the one third through-hole 466A of the third stencil layer 436. In some instances, these corresponding through-holes may be arranged along an axis that is perpendicular to the first axis 456. Here in FIG. 5, the one first through-hole 450A, the one second through-hole 458A, and the one third through-hole 466A correspond, or overlap, with each other and are arranged along a first stencil axis 474 that is perpendicular to the first axis 456. In some implementations, each through-hole may have their center axis on the first stencil axis 474 and the through-holes maybe considered coaxial to each other. In other implementations, at least one through-hole may not be colinear with another through-hole such that its center axis is offset from another through-hole in a direction perpendicular to this first stencil axis 474; this is described further below.

As also seen in FIG. 5, another first through-hole 450B of the first stencil layer 432 at least partially overlaps with another second through-hole 458B of the second stencil layer 434 and at least partially overlaps with another third through-hole 466B of the third stencil layer 436. The other second through-hole 458B at least partially overlaps with the third through-hole 466B of the third stencil layer 436. These three through-holes may also be arranged along a stencil axis 476 perpendicular to the first axis 456. The third first through-hole 450C of the first stencil layer 432 at least partially overlaps with the third second through-hole 458C of the second stencil layer 434 and at least partially overlaps with the third through-hole 466C of the third stencil layer 436. The third second through-hole 458C at least partially overlaps with the third through-hole 466C of the third stencil layer 436. These three through-holes may also be arranged along a stencil axis perpendicular 478 to the first axis 456.

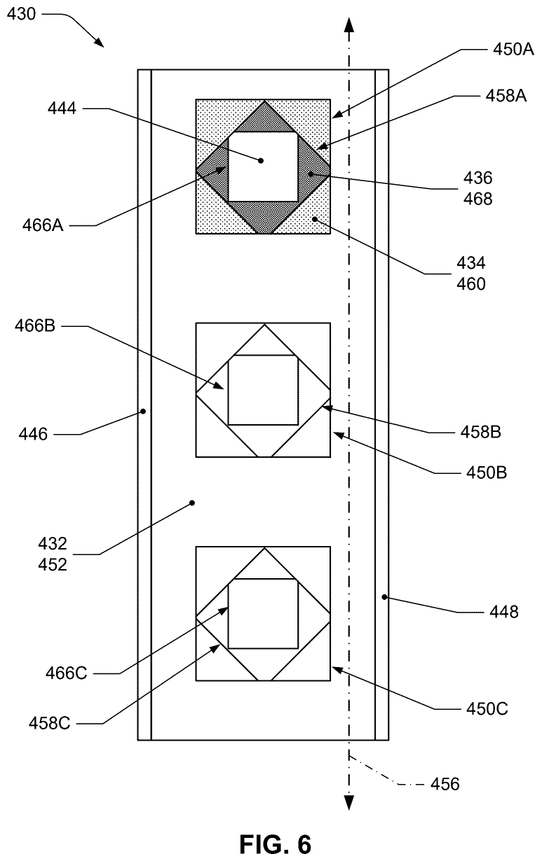

Some aspects of the overlap between through-holes of the stencil layer are illustrated in FIG. 6 which depicts a front view of the system of FIG. 4. Here, the first stencil layer 432 and its first front surface 452 and first axis 456 are shown, along with the first and second sides 446 and 448. The plurality of first through-holes 450A-450C of the first stencil layer 432 are illustrated as squares here. Each first through-hole 450A-450C provides a line of sight, or visibility to, the other stencil layers, and their respective through-holes, that are positioned behind or underneath the first stencil layer. Here in FIG. 6, each first through-holes 450A-450C provides visibility, or a line of sight, to portions of the second stencil layer 434, the second through-holes 458A-458C of the second stencil layer 434, portions of the third stencil layer 436, and the third through-holes 466A-466C. For example, visible through the first through-hole 450A, which overlaps with the second through-hole 458A, is the second through-hole 458A, a portion of the second front surface 460 of the second stencil layer 434, the third through-hole 466A, and a portion of the third front surface 468 of the third stencil layer 436. In some instances, like with system 430, the back layer 444 is visible through the third through hole 466A. For clarity, the portion of the second front surface 460 of the second stencil layer 434 visible through the first stencil layer 432 has light shading, and the portion of the third front surface 468 of the third stencil layer 436 visible through the first and second through-holes 450A and 458A has dark shading.

Similarly, visible through the second first through-hole 450B, which overlaps with the second through-hole 458B, is the second through-hole 458B, another portion of the second front surface 460 of the second stencil layer 434, the third through-hole 466B, and another portion of the third front surface 468 of the third stencil layer 436. Also, the third first through-hole 450B overlaps with the second through-hole 458B and provides a line of sight to the second through-hole 458C, another portion of the second front surface 460 of the second stencil layer 434, the third through-hole 466C, and another portion of the third front surface 468 of the third stencil layer 436.

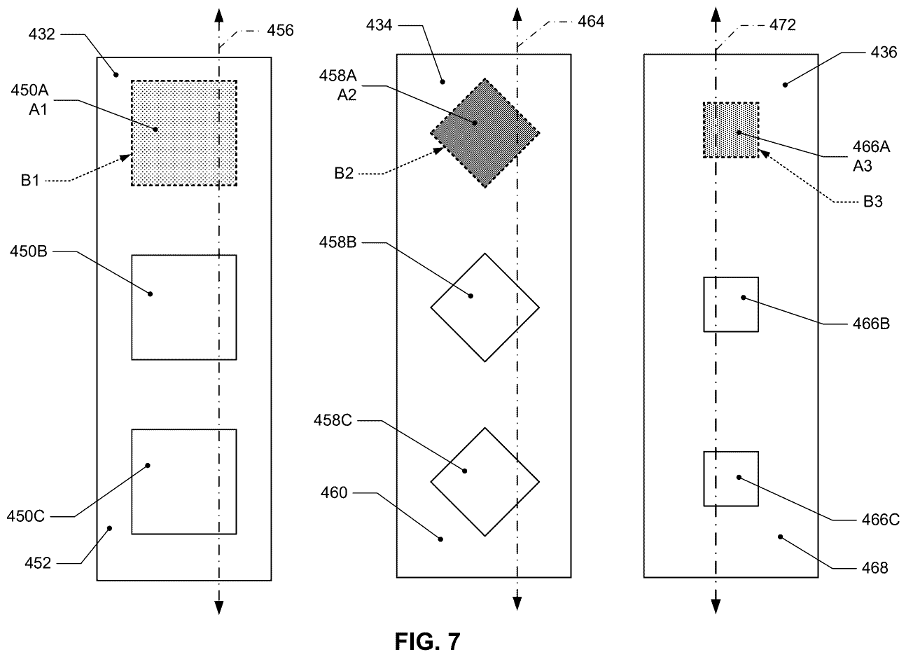

Various configurations of the through-holes of each layer provide the visibility to other layers and through-holes. FIG. 7 depicts a plan view of the first, second, and third stencil layers of FIG. 4. The first stencil layer 432 has the three first through-holes 450A-450C arrayed along the first axis 456, and the first front surface 452. The second stencil layer 434 has the three second through-holes 458A-458C arrayed along the second axis 464, and the second front surface 460. The third stencil layer 436 has the three third through-holes 466A-466C arrayed along the third axis 472, and the third front surface 468.

In some implementations, the areas of the first through-holes of the topmost layer may be larger than the areas of through-holes of the other stencil layers. In some instances, the areas of the through-holes of a respective upper stencil layer may be larger than the areas of the through-holes of the respective lower stencil layer. For instance, each first through-hole 450A-450C may have a first area A1, illustrated by the boundary B1 of first through-hole 450A being shown with dashed lines and its area A1 defined by the boundary B1 having light shading. Each second through-hole 458A-458C may have a second area A2, that is smaller than the first area A1, and that is illustrated by the boundary B2 of second through-hole 458A being shown with dashed lines and its area A2 defined by the boundary B2 having dark shading. Similarly, each third through-hole 466A-466C may have a third area A3 and the second area A2 of each second through-hole 458A-458C may be larger than the first area A3. For third through-hole 466A, its boundary B3 is shown with dashed lines and its area A3 defined by the boundary B3 has light shading. In some instances, having shapes with the largest areas in the topmost stencil layer, and each layer underneath having sequentially smaller areas provides for unique visual effects, including when the areas between such layers are sequentially illuminated by the pluralities of LEDs.

In addition to providing visibility to one or more lower stencil layers, the through-hole of the respective upper stencil layer defines, or frames, a shape of a respective lower stencil layer. This shape creation may be further provided by illuminating the gap between the two adjacent stencil layers. Various aspects of illuminating the gap between the stencil layers will now be discussed. Referring back to FIG. 4, the stencil layers 432, 434, and 436 are offset from each other by the offset distances OD1, OD2, and OD3, respectively, to create gaps or areas between two adjacent stencil layers as provided above. The plurality of LEDs positioned between two adjacent layers are configured to illuminate these gaps or areas.

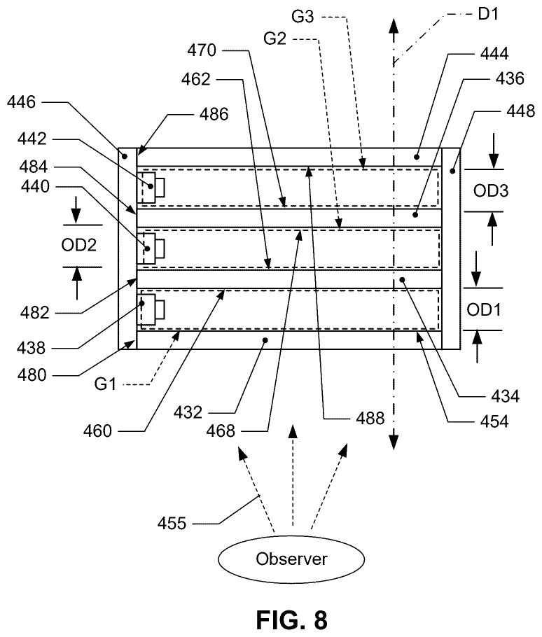

FIG. 8 depicts a top view of the system of FIG. 4. The first stencil layer 432, second stencil layer 434, and third stencil layer 436 are shown with the first side 446, second side 448, and back layer 444. The first stencil layer 432 and second stencil layer 432 are offset from each other in the direction D1 by the first offset distance OD1 and a first gap G1 is created between the first and second stencil layers 432 and 434. The first gap G1 is illustrated with a dashed boundary. As provided herein, the first stencil layer 432 may be considered the topmost layer such that it is the closest to an observer as illustrated. The lines of sight 495 emanating from the observer hit the first stencil layer 432 first. The first plurality of LEDs 438 is positioned proximate to a first edge 480 of the first stencil layer 432 and a second edge 482 of the second stencil layer 434. In some instances, like shown, the first plurality of LEDs 438 is positioned inside the first gap G1 between the first and second stencil layers 432 and 434. The first plurality of LEDs 438 is configured to emit light into the first gap G1 and illuminate the first gap G1. This may include illuminating the first back surface 454 of the first stencil layer 432 and the second front surface 460 of the second stencil layer 434.

The second stencil layer 432 and the third stencil layer 436 are offset from each other in the direction D1 by the second offset distance OD2 and a second gap G2 is created between the second and third stencil layers 434 and 436. The second gap G2 is illustrated with a dashed boundary. The second plurality of LEDs 440 is positioned proximate to the second edge 482 of the second stencil layer 434 and a third edge 484 of the third stencil layer 436. In some instances, like shown, the second plurality of LEDs 440 is positioned inside the second gap G2 between the second and third stencil layers 434 and 436. The second plurality of LEDs 440 is configured to emit light into the second gap G2 and illuminate the second gap G2. This may include illuminating the second back surface 462 of the second stencil layer 434 and the third front surface 468 of the third stencil layer 436.

The third stencil layer 432 and the back layer 444 are offset from each other in the direction D1 by the third offset distance OD3 and a third gap G3 is created between the third and back stencil layers 436 and 444. The third gap G3 is illustrated with a dashed boundary. The third plurality of LEDs 442 is positioned proximate to the third edge 484 of the third stencil layer 436 and an edge 486 of the back layer 444. In some instances, like shown, the third plurality of LEDs 442 is positioned inside the third gap G3 between the third stencil layer 436 and back layer 444. The third plurality of LEDs 442 is configured to emit light into the third gap G3 and illuminate the third gap G3. This may include illuminating the third back surface 470 of the third stencil layer 436 and a front surface 488 of the back layer 444 (also identified in FIG. 6).

In some implementations, the offset distances OD1-OD3 may be the same as each other and in other implementations at least one offset distance may be different than another. The offset distances OD1-OD3 may range from about 3 mm to about 15 mm, about 4 mm to about 10 mm, or about 6 mm to about 10 mm, for example. Each plurality of LEDs may also have a width that ranges from about 2 mm to about 15 mm, about 4 mm to about 10 mm, or about 5 mm to about 8 mm, for example.

Illuminating each gap between two adjacent stencil layers is configured to create a visual effect that illuminates aspects of one or more of the stencil layers and illuminating the gaps, sequentially or not all at the same time, can create visual effects of the various shapes. For example, the through-holes of a respective upper stencil layer is configured to define, or frame, an illuminated shape of a respective lower stencil layer. When this respective lower stencil layer has through-holes, they further define the illuminated shape of this lower stencil layer.

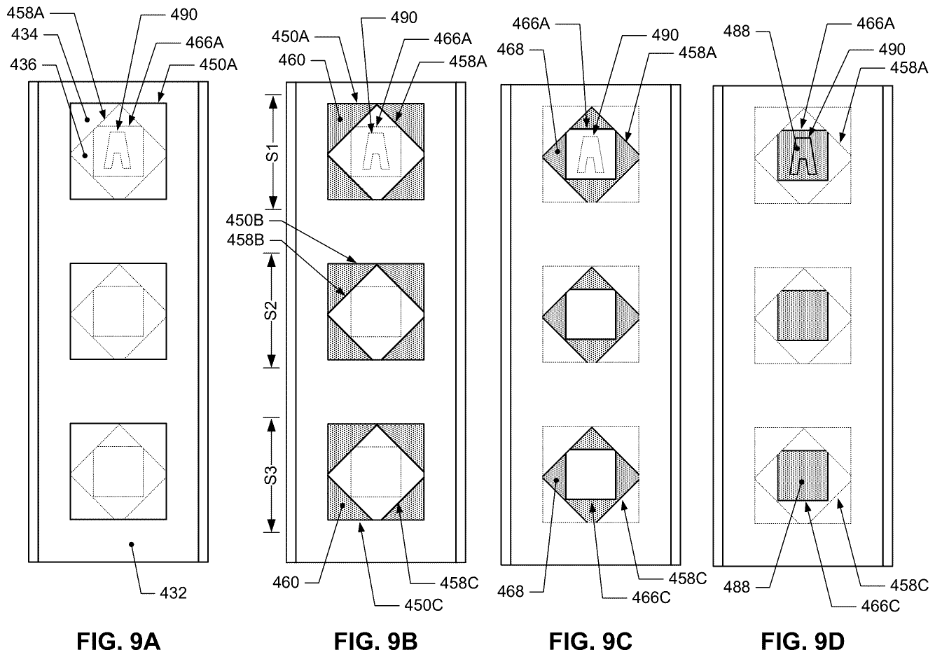

Some of these visual effects are illustrated in FIGS. 9A to 9D which depict a front view of the system of FIG. 4 with various illustrated illuminations of the gaps between stencil layers. In FIG. 9A, the system is illustrated as having no illumination by any of the LEDs. In some instances, when none of the gaps between the stencil layers are illuminated some of the shapes of the first through-holes 450A may or may not be visible and the remaining through-holes and stencil layers may also not be visible. In this example, features with light-weight dotted lines indicate features that are present and not illuminated, and features with heavy weight lines and shading indicate features that are illuminated. In FIG. 9A, the first gap G1, the second gap G2, and the third gap G3 are not illuminated by any of the plurality of LEDs. Due to this the first through-holes 450A may or may not be visible due to ambient lighting where the system 430 may be located. The other stencil layers and their respective through-holes may not be visible as indicated by their light-weight dotted lines.

In FIG. 9B, the first gap G1 is illuminated by the first plurality of LEDs 438, while the second gap G2 is not illuminated by the second plurality of LEDs 440 and the third gap G3 is not illuminated by the third plurality of LEDs 442. By illuminating the first gap G1, the second front surface 460 of the second stencil layer 434 is illuminated, as indicated by its shading, and the second through holes 458A-458C are also visible, as indicated by their heavy-weight solid lines. In some instances, this illumination may also illuminate the first through-holes 450A-450C of the first stencil layer 432.

The first through-holes 450A-450C are also seen framing, or defining by forming boundaries of, the visible aspects of the second front surface 460 of the second stencil layer 434. As further illustrated, in some instances these first through-holes 450A-450C define the outer boundaries of the portion of the second stencil layer 434 seen through the first through-holes 450A-450C. The second through-holes 458A-458C also may define the portion of the second stencil layer 434 seen through the first though-holes. Here in FIG. 9B for example, the second through-hole 458A of the second stencil layer 434 further defines the illuminated shape of the second stencil layer 434 by creating four visible and illuminated triangles. These triangles are shaded and one is labeled 460. The third stencil layer 436 and its third through-holes may remain non-illuminated. For clarity, only some labels are provided herein.

In FIG. 9C, the second gap G2 is illuminated by the second plurality of LEDs 440, while the first gap G1 is not illuminated by the first plurality of LEDs 438 and the third gap G3 is not illuminated by the third plurality of LEDs 442. By illuminating the second gap G2, the third front surface 468 of the third stencil layer 436 is illuminated, as indicated by its shading, and the third through holes 466A-466C are also visible, as indicated by their heavy-weight solid lines. In some instances, this illumination may also illuminate the second through-holes 458A-458C of the second stencil layer 434. For clarity, only some labels are provided herein.

The second through-holes 458A-458C are also seen framing, or defining by forming boundaries of, the visible aspects of the third front surface 468 of the third stencil layer 436. As further illustrated, in some instances these second through-holes 458A-458C define the outer boundaries of the portion of the third stencil layer 436 seen through the second through-holes 458A-458C. The third through-holes 466A-466C also may define the portion of the third stencil layer 436 seen through the second though-holes. Here in FIG. 9C for example, the third through-hole 466A of the third stencil layer 436 further defines the illuminated shape of the third stencil layer 436 by creating four visible and illuminated triangles, one of which is labeled 468, which are different than the triangles in FIG. 9B.

In FIG. 9D, the third gap G3 is illuminated by the third plurality of LEDs 442, while the first gap G1 is not illuminated by the first plurality of LEDs 438 and the second gap G2 is not illuminated by the second plurality of LEDs 440. By illuminating the third gap G3, the surface 488 of the back layer 444 is illuminated, as indicated by its shading, and the third through-holes 466A-466C of the third stencil layer 436 may also be visible as indicated by their heavy-weight solid lines. For clarity, only some labels are provided herein. The third through-holes 466A-466C are also seen framing, or defining by forming boundaries of, the visible aspects of the surface 488 of the back layer 444. In this instance, the third through-holes 466A-466C define visible squares of the back layer 444.

In some implementations, the back layer may not have through-holes and may instead have shapes raised, sunk, or otherwise defined into the back layer which may be illuminated by the plurality of LEDs between the back layer and the immediately adjacent stencil layer. These shapes may be aligned with respective through-holes of the other stencil layer(s) such that the through-hole of the immediately adjacent stencil layer overlaps with the respective shape. Referring back to FIG. 5, the back layer 444 has a shape 490 provided thereon, which is the letter “A” in this example. The letter may be raised or lowered with respect to the rest of the surface 488. This letter may also be visible through all the pluralities of through-holes 450A, 458A, and 466A, such as when the third plurality of LEDs 442 illuminates the third gap G3. This is illustrated in FIGS. 9A-9D. In FIGS. 9A-9C, the shape 490 is present and not yet visible until the third plurality of LEDs 442 illuminates the third gap G3 in FIG. 9D.

The gaps between two adjacent stencil layers may be illuminated in various sequences. In some implementations, one gap between two adjacent layers may be illuminated while one or more other gaps between adjacent layers are not illuminated. Some implementations may sequentially illuminate each gap beginning at the topmost layer and ending at the backmost gap.

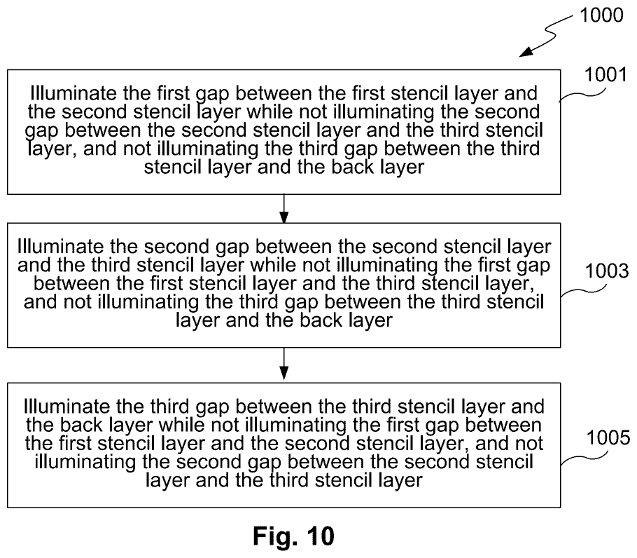

FIG. 10 depicts a first example illumination sequence and reference is made to FIGS. 9A-9D. For block 1001 in the first example illumination sequence 1000, the illumination of FIG. 9B may be provided in which the first gap G1 is illuminated by the first plurality of LEDs 438, while the second gap G2 is not illuminated by the second plurality of LEDs 440 and the third gap G3 is not illuminated by the third plurality of LEDs 442. For the second block 1003, the illumination of FIG. 9C may be provided in which the second gap G2 is illuminated by the second plurality of LEDs 440, while the first gap G1 is not illuminated by the first plurality of LEDs 438 and the third gap G3 is not illuminated by the third plurality of LEDs 442. For the third block 1005, the illumination of FIG. 9D may be provided in which the third gap G3 is illuminated by the third plurality of LEDs 442, while the first gap G1 is not illuminated by the first plurality of LEDs 438 and the second gap G2 is not illuminated by the second plurality of LEDs 440.

In some instances, the blocks of the first example sequence 1000 may be repeated or performed in different orders. For example, blocks 1001, 1003, and 1005 may be performed in that order. In another example, after performing blocks 1001, 1003, and 1005, this same order of blocks may be repeated. In yet another example, after performing blocks 1001, 1003, and 1005, the blocks may be performed in reverse order, such as performing block 1005, then 1003, then 1001. In some other instances, these blocks may be executed in nonconsecutive orders, such as block 1001, then block 1005, then block 1003. In some instances, the illumination of FIG. 9A, which is no illumination, may also be included in any illumination sequence.

The lighting of each gap by the pluralities of LEDs may also be performed in various manners. When illuminating a gap between two adjacent stencil layers, the pluralities of LEDs may emit their light in multiple ways, such as all the LEDs emitting light at once, a gradual increase in brightness, some LEDs emitting light while others are not, some LEDs emitting light at one brightness while other LEDs are emitting light at a different brightness, or a combination thereof. In some such instances, the brightness of the LEDs along the length of the first axis may shift which may create an effect of moving light or motion along the length of the first axis and the system. For example, referring to FIG. 9B, the pluralities of LEDs may illuminate all of the gap G1 between the first and second stencil layers 432 and 434, as shown.

In another example, a first subset S1 of LEDs of the first plurality of LEDs 438 adjacent to the first through-hole 450A and second through-hole 458A may illuminate the gap G1 at a first brightness. At the same time, a second subset S2 of LEDs of the first plurality of LEDs 438 adjacent to the first through-hole 450B and second through-hole 458B may illuminate the gap G1 at a second brightness different than the first brightness. In some cases, the second brightness may be zero, less than the first brightness, or greater than the first brightness. A third subset S3 of LEDs of the first plurality of LEDs 438 adjacent to the third first through-hole 450C and second through-hole 458C may also illuminate the gap G1 at a third brightness that may be the same or different than the first brightness. In some instances, the third brightness may be zero, less than the first brightness, equal to the first brightness, greater than the first brightness, less than the second brightness, equal to the second brightness, or greater than the second brightness.

The light emissions between different pluralities of LEDs may also vary. This may include various illumination sequences for transitioning from illuminating one gap, or a portion thereof, between two adjacent stencil layers and illuminating another gap, or a portion thereof, between two other adjacent stencil layers. In some implementations, referring to FIG. 8, the first gap G1 may be illuminated and transition to illuminating the second gap G1, the first plurality of LEDs 438 may turn off, or reduce their brightness to zero, and after that, the second plurality of LEDs 440 may turn on, or increase their brightness to a non-zero value. In some instances, the illumination by the two pluralities of LEDs 438 and 440 may be gradual such that the first plurality of LEDs 438 reduces its brightness while the second plurality of LEDs 440 concurrently increases its brightness.

In some implementations, the pluralities of LEDs may be configured to emit one or more colors, such as white, red, blue, yellow, green, purple, orange, any color on the color wheel, or a combination thereof. The pluralities of LEDs may therefore be configured to illuminate the respective gap between two stencil layers with one or more colors.

Additional or alternative features of the layered stencil lightbox system will now be discussed. Turning to the shapes of the through-holes, in some implementations, the through-hole shapes of at least two stencil layers may be the same. Referring back to FIG. 7, the first through-holes 450A-450C and the third through-holes 466A-466C are both squares, albeit differently sized. Similarly, the second through-holes of the second stencil layer may also be considered squares, although they are at a different orientation than the first through-holes 450A-450C and the third through-holes 466A-466C.

In some implementations, the shapes of the through-holes of at least two stencil layers may be different from each other. In one example, the through-holes of the first stencil layer may have a first shape and the second through-holes of the second stencil layer may have a second shape different than the first shape. The through-holes of the third stencil layer may have a third shape that may be different than the first shape of the first stencil layer, the second shape of the second stencil layer, or both. The various shapes of the through-holes may differ and range from geometric shapes, like squares, rectangles, circles, triangles, obrounds, ellipses, trapezoids, hexagons, pentagons, octagons, etc., to letters, numbers, words, and individual images like animals (e.g., buffalos, dragons, tigers), sports shapes (e.g., soccer balls, footballs, basketballs), other items that may be related to a game theme for an electronic gaming machine, like a pot of gold, fireworks, coins, money, etc.

In some implementations, the through-holes of the first stencil layer and the through-holes of the second stencil layer may be oriented at an angular offset with respect to each other. For instance, the second through-holes 458A-458C may be considered diamonds, or squares rotated to a different angle than the first through-holes 450A-450C. This angle may be greater than 0 degrees and less than 360 degrees, such as 15 degrees, 30 degrees, etc. In some instances, providing an angular offset between two shapes in different stencil layers may further provide the visual effect of movement of the shapes.

In some implementations, the areas of the through-holes of at least two adjacent stencils layers may be the same, but the through-hole shapes, orientations, positions, or a combination thereof may be different between stencil layers. This may include the through-holes of a respective upper stencil layer, having the same shape as the through-holes of the stencil layer immediately underneath, i.e., the lower stencil layer. To provide a line of sight through the upper stencil layer to a portion of the underneath through-holes and lower stencil layer, which may create a movement effect, the angular orientation of the through-holes in the lower stencil layer may be different, such as rotated by a particular angle. In some instances, these through-holes of the upper and lower stencil layers may be colinear with each other. In other instances, the through-holes of the lower stencil layer may be offset from the through-holes of the upper stencil layer, such that their center axes are not colinear. In yet other examples, the shapes of the through-holes of the upper and lower stencil layers may be different and still have the same area. The positioning of such through-holes may be the same as provided above.

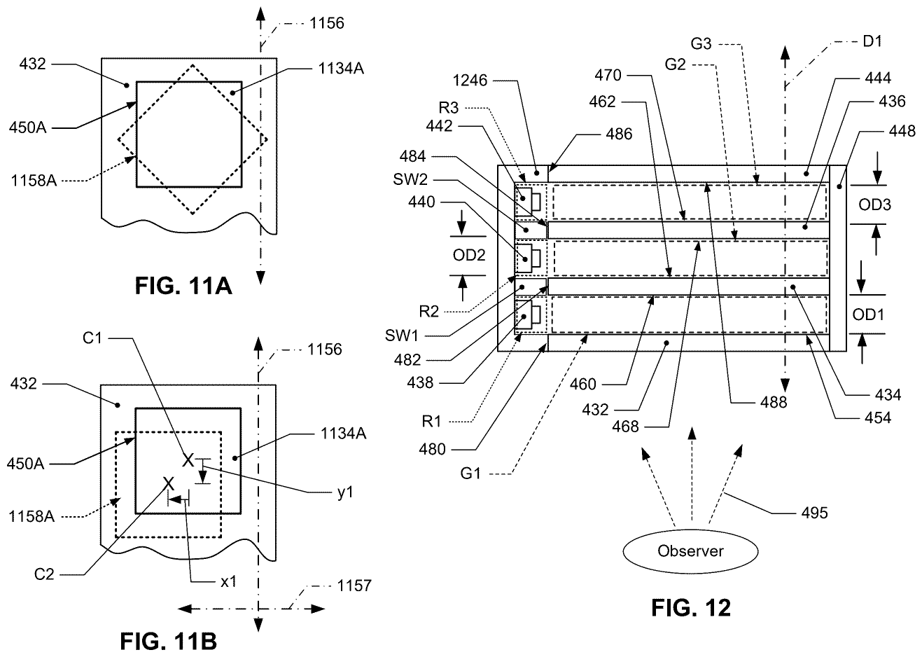

FIGS. 11A and 11B depict plan views of portions of two stacked stencil layers. In FIG. 11A, a portion of a first stencil layer, like stencil layer 432, having a first through-hole 450A and first axis 456 is depicted, along with a second stencil layer 1134A having a second through-hole 1158A behind the first stencil layer 432. The second through-hole 1158A, with its boundary depicted as a dotted line to differentiate it from the first through-hole 450A, has the same shape and same area size as first through-hole 450A, but the second through-hole 1158A is oriented at a different angle with respect to the first axis 456. By having the two stencil layers with through-holes having the same shape and size as each other, but at different orientations with respect to each other, a line of sight may still be provided from the first stencil layer 1132A to the second stencil layer 1134 and its second through-hole 1158A.

In FIG. 11B, the same portion of the first stencil layer 432 of FIG. 11A is illustrated along with another second stencil layer 1134B having a second through-hole 1158B behind the first stencil layer 432. The second through-hole 1158B, with its boundary depicted as a dotted line to differentiate it from the first through-hole 450A, has the same shape and same size as first through-hole 450A, but the second through-hole 1158B is in a different position with respect to the first through-hole 450A and the first axis 456. The relative position of the first through-hole 450A and the second through-hole 1158B may be based on the center axes of each through-hole, respectively, and the first axis 456. Here, the first through-hole 450A has a first center axis C1 and the second through-hole 1158B has a second center axis C2 which is located a distance x1 from the first center axis C1 in a direction 1157 perpendicular to the first axis 456 and located a distance y1 from the first center axis C1 in a direction parallel to the first axis 456. By having the two stencil layers with through-holes having the same shape and size as each other, but in different positions with respect to each other, a line of sight may still be provided from the first stencil layer 1132A to the second stencil layer 1134 and its second through-hole 1158B.

In some implementations, the first side of the system may be configured differently than above, such as positioning the LEDs adjacent and offset from the stencil layers. FIG. 12 depicts a top view of another system. This system 1230 is similar to that of FIG. 8 and system 430, with noted differences. Here, the system 1230 has the same first, second, and third stencil layers 432, 434, and 436, back layer 444, and second side 448. The first side 1246 is configured differently than the first side 446. As can be seen, the first side 1246 has recesses to receive each plurality of LEDs so that the pluralities of LEDs are not within the gaps between adjacent stencil layers. More specifically, the first side 1246 has a first recess R1 where the first plurality of LEDs 438 is positioned. The first recess R1 positions the first plurality of LEDs 438 offset from, and still adjacent to, the first gap G1. The first plurality of LEDs 438 is still configured to illuminate the first gap G1 as provided herein. This positioning may advantageously prevent a line of sight through the first through-holes to the LEDs themselves.

Similarly, the second recess R2 positions the second plurality of LEDs 440 offset from, and still adjacent to, the second gap G2. The second plurality of LEDs 440 is configured to illuminate the second gap G2 as provided herein. This positioning may advantageously prevent a line of sight through the first through-holes and the second through-holes to the LEDs. The third recess R3 also positions the third plurality of LEDs 442 offset from, and still adjacent to, the third gap G3. The third plurality of LEDs 442 is configured to illuminate the third gap G3 as provided herein. This positioning may advantageously prevent a line of sight through the first through-holes, the second through-holes, and the third through-holes to the LEDs. To prevent light from one plurality of LEDs illuminating a different gap, the first side 1246 has sidewalls SW1 and SW2 to partially define the recesses R1-R3 and prevent this light bleeding from adjacent LEDs. For instance, side wall SW1 prevents light from the first plurality of LEDs 438 shining through to the second gap G2.

The materials of the stencil layers may be configured to provide the desired visual effects of the lightbox system. In some implementations, this may include each stencil layer being comprised of an opaque material such that light does not pass through the material itself. In some implementations, this may include some of the surfaces of the stencil layers having reflective, refractive, light-dampening, or light-scattering properties. This may include the material of the stencil layers having such properties, such as embedded within the material. This may also include surface texturing of the stencil layer surfaces, such as polishing, creating rough texturing, lines, circles, or other linear and nonlinear texturing. In some other instances, a coating of material may be provided on the front surface, the back surface, or both of the stencil layers and this material coating may have reflective properties, such as a reflective color. For example, referring back to FIG. 5, the first back surface 454 of the first stencil layer 432, the second front and back surfaces 460 and 462 of the second stencil layer 434, and the third front and back surfaces 468 and 470 of the third stencil layer 436 may have such reflective, refractive, or light-scattering properties in their layers or in a coating on each surface.

Some implementations of the layered stencil lightbox system may also have additional layers of material configured to provide additional visual effects. This may include a transparent or semi-transparent layer of material positioned between two adjacent stencil layers. This layer of material may have one or more features configured to affect light emitting within the gap between the two adjacent stencil layers, such as scattering, reflecting, and refracting the light.

The layered stencil lightbox systems provided herein may have two or more stencil layers in some instances. The example provided above has three stencil layers and in other cases, the systems may have more or less stencil layers, such as two stencil layers, four stencil layers, five stencil layers, or more. The back layer may also be considered a stencil layer without any through-holes. In some implementations, the back layer may or may not have through-holes.

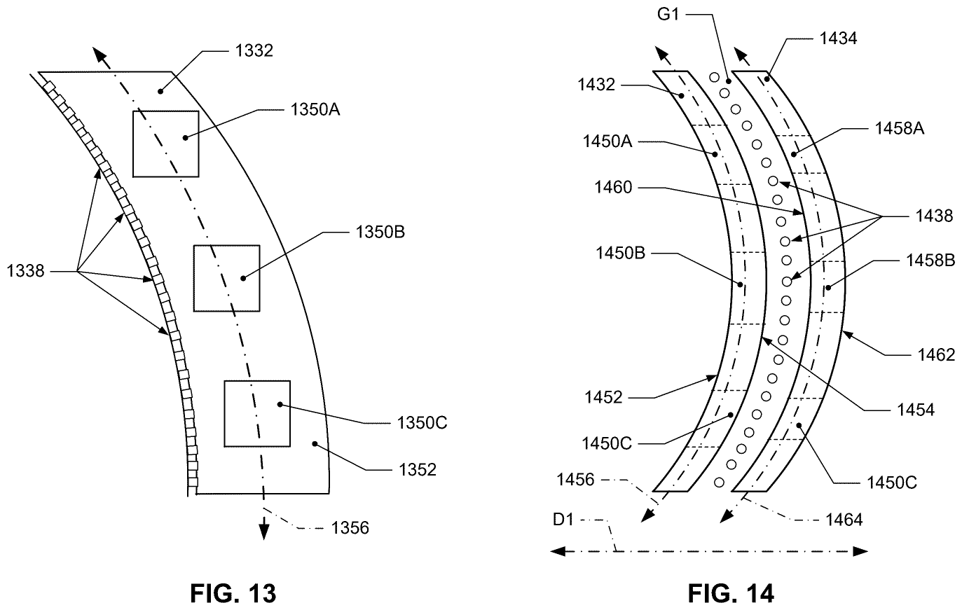

In some implementations, the axes of the stencil layers may be linear as provided above. In some other implementations, the axes of the stencil layers may be curved in various manners. For example, the stencil layers may have planar (e.g., flat) front and back surfaces and these planar surfaces may be curved a direction parallel to the surfaces. FIG. 13 depicts a front view of a first example curved stencil layer. Here, the stencil layer 1332 has a first front surface 1352 that may be considered planar and has three through-holes 1350A, 1350B, and 1350C that extend through the stencil layer 1332. The stencil layer 1332 is curved in the plane of the planar first front surface 1352 such that the stencil layer extends along the curved first axis 1356. The through-holes 1350A, 1350B, and 1350C are also seen arrayed along this curved first axis 1356. When this stencil layer 1332 is provided in a system, the remaining features are also similarly curved, such as the other stencil layers offset from this stencil layer 1332 in a direction perpendicular to the curved first axis 1356. The pluralities of LEDs 1338 are also curved along one edge of the curved stencil layer 1332.

In another example, the stencil layers may have curved front and back surfaces such that these surfaces are nonplanar. FIG. 14 depicts a side view of two curved stencil layers and a plurality of LEDs. Here, the first stencil layer 1432 has a first front surface 1452 and a first back surface 1454 that are both curved and nonplanar. The first stencil layer 1432 has three through-holes 1450A, 1450B, and 1450C that extend through the first stencil layer 1432, are shown with dashed lines, and arrayed along the first axis 1456. In this example, the planes of the first front surface 1452 and first back surface 1454 are curved such that the stencil layer extends along the curved first axis 1456. When this stencil layer 1432 is provided in a system, the remaining features are also similarly curved, such as the other stencil layers offset from this stencil layer 1332 in the direction D1 perpendicular to the curved first axis 1456. As can be seen, the second stencil layer 1434 has a second front surface 1460 and second back surface 1462 that are both curved and nonplanar. The second stencil layer 1434 has three through-holes 1458A, 1458B, and 1458C that extend through the second stencil layer 1434, are shown with dashed lines, and arrayed along the second axis 1464. Like the first stencil layer 1432, the planes of the second front surface 1460 and second back surface 1462 are curved such that the length of second stencil layer extends along the curved second axis 1464. The pluralities of LEDs 1438 are also curved along and configured to illuminate the gap G1 between these two curved stencil layers.

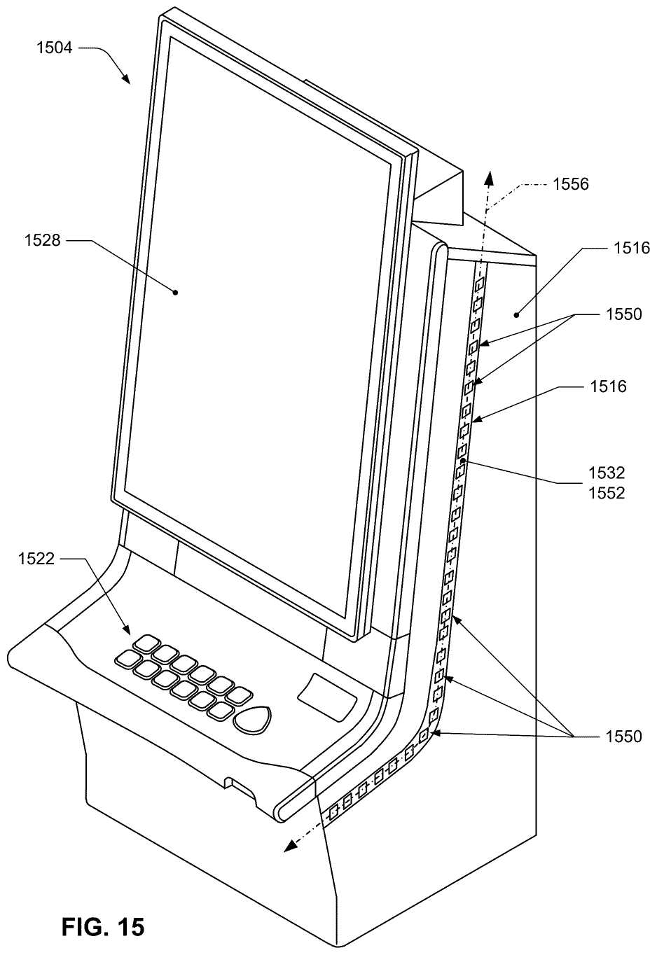

As provided above, the layered stencil lightbox systems may a part of an electronic gaming machine (EGM). Such systems may be positioned in various locations on the EGM, such as adjacent to a display, on a cabinet facing a player, on a side of a cabinet, or a combination thereof. FIG. 15 depicts an example electronic gaming machine with a layered stencil lightbox system. The EGM 1504 here may be any of those provided above, and it may have a main display 1528, a main cabinet 1516, and a plurality of inputs, like buttons 1522. The EGM 1504 also has a layered stencil lightbox system 1530 on the main cabinet 1516 which in this instance is a side of the main cabinet 1516. The system 1530 may be at least partially positioned inside the main cabinet 1516 and the first stencil layer 1532 is facing outwards and may form a surface of the main cabinet 1516. The plurality of first through-holes 1550 of the first stencil layer 1532, depicted as squares, are arrayed along the first axis 1556 of the first stencil layer 1532. The first axis 1556 has both linear and nonlinear portions. Here, the first front surface 1552 may be considered planar and curved in the plane, similar to that of FIG. 13. The layered stencil lightbox system 1530 may have one or more other stencil layers and pluralities of LEDs as provided herein, and which may be positioned within the main cabinet 1516. The layered stencil lightbox system 1530 is configured to illuminate the gap between its stencil layers as also provided herein.

In some implementations, a system may also include a plurality of transparent layers of material, and the system may be arranged such that a stencil layer is adjacent to one or more of the transparent layers of material and the plurality of LEDs are positioned to illuminate the inside of the transparent layers. The stencil layers may be a coating or a separate layer of material that is coupled to, or positioned adjacent to, a front surface or a back surface of a respective transparent layer of material. In some instances, a transparent layer of material may have various features configured to reflect or refract light emitted into the layer, such as texturing on a front or back surface, as well as texturing that extends through at least a part of the thickness of the transparent layer, such as channels or holes extending partially through the transparent layer that extend around a boundary of a window of the transparent layer of material, around a boundary of through-hole of the stencil layer, or both. For example, each through-hole of a stencil layer may have an outer boundary, and the transparent layer of material may have texturing features arranged along a corresponding outer boundary, such as a channel partially cut into the transparent layer of material.

Referring back to the FIGS. 8 and 12, some systems have a transparent layer of material interposed between each stencil layer and in the gaps provided above. For example, a first transparent layer of material maybe positioned in the gap G1 between stencil layers 432 and 434, a second transparent layer of material maybe positioned in the gap G2 between stencil layers 434 and 436, and a third transparent layer of material maybe positioned in the gap G3 between stencil layers 436 and 444. Each plurality of LEDs is configured to illuminate the transparent layer of material in the respective gaps, such as the first plurality of LEDs 438 being configured to illuminate the first transparent layer of material in the gap G1.

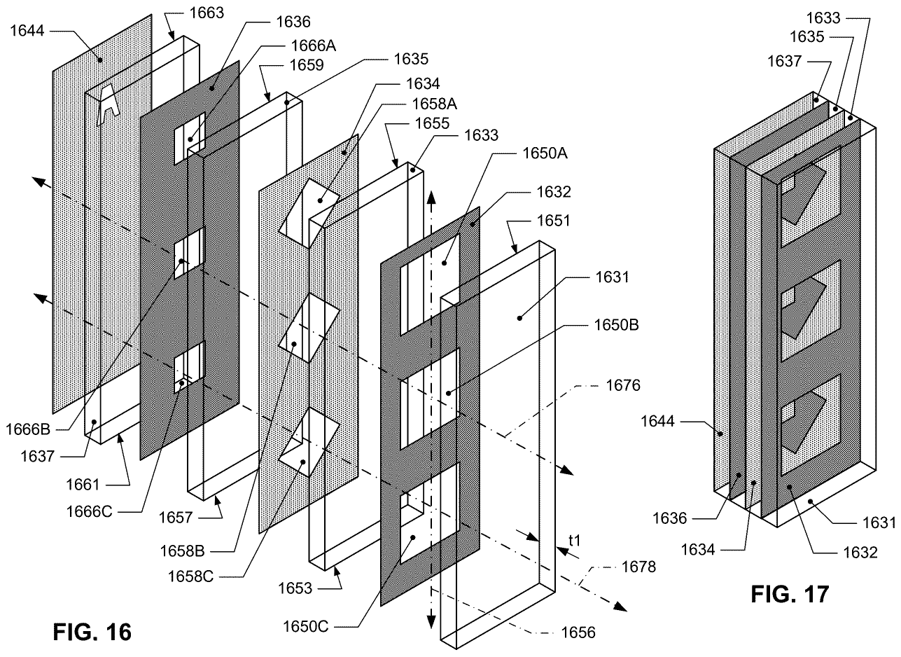

Further example systems with transparent layers of material will now be discussed. FIG. 16 depicts an off-angle exploded view of a portion of another layered stencil lightbox assembly and FIG. 17 depicts an off-angle view of the portion of the assembly of FIG. 16. Here, this system 1600 has a plurality of stencil layers 1632, 1634, and 1636 and a plurality of transparent layers of material, such as a first transparent layer of material 1631, a second transparent layer of material 1633, a third transparent layer of material 1635, and a fourth transparent layer of material 1637. The stencil layers 1632, 1634, and 1636 may be the same as provided above, such as illustrated in FIGS. 4-9D. For instance, the stencil layers 1632, 1634, and 1636 each have a plurality of through-holes arranged along the first, second, and third axes, respectively and extending fully through the respective stencil layer. As indicated in FIG. 16, the first stencil layer 1632 has a plurality of first through-holes 1650A, 1650B, and 1650C that are arranged along the first axis 1656 and extend fully through the first stencil layer 1632. The second stencil layer 1634 also has the plurality of second through-holes 1658A-1658C and the third stencil layer 1636 has the plurality of third through-holes 1666A-1666C, which may be configured in the same manner provided above. For example, each first through-hole and a respective second through-hole and a respective third through-hole are arranged along a respective stencil axis, like axes 1676 and 1678.

As can be seen in FIG. 16, the stencil layers LL32, 1634, and 1636 are each interposed between two transparent layers of material. The first stencil layer 1632 is interposed between first and second transparent layers of material 1631 and 1633, respectively, the second stencil layer 1634 is interposed between second and third transparent layers of material 1633 and 1635, respectively, and the third stencil layer 1636 is interposed between third and fourth transparent layers of material 1635 and 1637, respectively. The back or fourth stencil layer 1644 is positioned adjacent to the fourth transparent layer of material 1637.

The transparent layers of material 1631, 1633, 1635, and 1637 may comprise a transparent, or semi-transparent, material that provides visibility through the layer. Like above, the stencil layers 1632, 1634, and 1636 are comprised an opaque material that prevents a line of sight through the stencil layer except at the location of the through-holes. Each through-hole provides a line of sight to an adjacent transparent layer of material and stencil layer. In FIG. 16, for instance, the first transparent layer of material 1631 provides a line of sight through its thickness t1 to the first stencil layer 1632 which prevents a line of sight through its layer except at the locations of first through-holes 1650A-1650C. These first through-holes 1650A-1650C provide a line of sight to the adjacent second transparent layer of material 1633 which provides a line of sight to the adjacent second stencil layer 1634. These lines of sight are further discussed below.

In FIG. 17, when assembled together, the stencil layers may be in direct contact with one or more of the transparent layers of material. For instance, the first stencil layer 1632 is in direct contact with first and second transparent layers of material 1631 and 1633, respectively, the second stencil layer 1634 is in direct contact with second and third transparent layers of material 1633 and 1635, respectively, and the third stencil layer 1636 is in direct contact with third and fourth transparent layers of material 1635 and 1637, respectively. The back, or fourth, stencil layer 1644 is in direct contact with the fourth transparent layer of material 1637.

In some instances, the stencil layers may be coupled to one of the transparent layers of material. This coupling may be using an adhesive as well as screen printing, painting, applying a liquid material, or other form of applying the stencil layer to a transparent layer of material. In FIG. 16, for instance, the first stencil layer 1632 may be coupled, such as by an adhesive, to a back surface 1651 of the first transparent layer of material 1631, a front surface 1653 of the second transparent layer of material 1633, or both. In another instances, the first stencil layer of material 1631 may be painted, printed, or otherwise applied to the back surface 1651 or the front surface 1653 of the first transparent layer of material 1631. The second stencil layer 1634 may be coupled to a back surface 1655 of the second transparent layer of material 1633, a front surface 1657 of the third transparent layer of material 1635, or both. The third stencil layer 1636 may be coupled to a back surface 1659 of the third transparent layer of material 1635, a front surface 1661 of the fourth transparent layer of material 1637, or both. The fourth stencil layer 1644 may be coupled to a back surface 1663 of the fourth transparent layer of material 1637.

In some instances, the stencil layers may be thin films or layers of material applied to the transparent layers of material, such as sprayed or printed. In other instances, the stencil layers may be separate structures that are coupled to the transparent layers of material. In some implementations, the system may have one or more features connecting the stencil layers and transparent layers of material, such as clamps, bolts, threads, bindings, or the like.

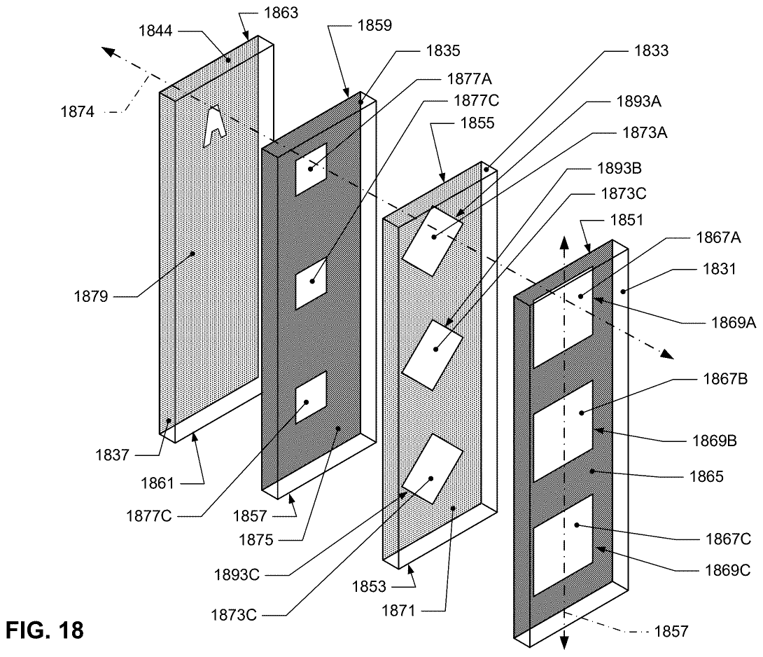

In some implementations, the transparent layers may have portions that are at least partially opaque and that prevent or limit visibility through the layer, and a plurality of windows that provide visibility through the layer. The opaque or semi-opaque portion may be texturing or other surface treatment that obstructs or partially obstructs lines of sight through the layer. FIG. 18 depicts an off-angle exploded view of a portion of yet another layered stencil lightbox assembly. Here, four transparent layers of material 1831, 1833, 1835, and 1837 are illustrated, and each has a surface with a portion that is at least partially opaque and that prevents, or limits visibility, and a plurality of windows that each provide a line of sight through the layer. In some instances, like illustrated in FIG. 18, this assembly does not have the stencil layers provided herein.

As can be seen in FIG. 18, the first back surface 1851 of the first transparent layer 1831 has an at least partially opaque portion 1865, illustrated with dark shading, that is at least partially opaque and has a plurality of first windows 1867A, 1867B, and 1867C arranged along a first axis 1857. Each first window 1867A, 1867B, and 1867C provides a line of sight through the first back surface 1851, such as to the other layers. In some instances, this first back surface 1851 may be configured to act as a stencil layer which prevents, or limits, a line of sight through the first transparent layer of material 1831, except through the plurality of windows 1867A, 1867B, and 1867C which act like the through-holes by providing lines of sight to an adjacent layer. Each first window 1867A, 1867B, and 1867C is defined by a first window boundary 1869A, 1869B, and 1869C, respectively, that has a shape. Here, these first window boundaries 1869A, 1869B, and 1869C have a square shape. As can be seen, the first back surface 1851 is not opaque within each first window boundary 1869A, 1869B, and 1869C and the other transparent layers of material 1833, 1835, and 1837 are visible through these windows.

The second transparent layer of material 1833 also has a second back surface 1855 that has a second at least partially opaque portion 1871, shown with light shading, that is at least partially opaque and that has a plurality of second windows 1873A-1873C that provide visibility through the second back surface 1855 to the adjacent layers. These second windows 1873A-1873C also have second boundaries 1893A-1893C, respectively, that define each second window. Similarly, the third transparent layer of material 1835 also has a third back surface 1859 that has a third at least partially opaque portion 1875, shown with dark shading, that is at least partially opaque and that has a plurality of third windows 1877A-1877C that provide visibility through to the adjacent layer 1844 which also has an at least partially opaque portion 1879 on its back surface 1863. These third windows 1877A-1873A also have third boundaries, respectively, that define each third window, although these are not labeled for clarity.

Similar to the through-holes provided above, the windows of these layers at least partially overlap with each other. For example, the first window 1867A of the first transparent layer of material 1831, the second window 1873A of the second transparent layer of material 1833, and the third window 1877A of the third transparent layer of material 1835 correspond, or overlap, with each other and are arranged along a stencil axis 1874 that is perpendicular to the first axis 1857. In some implementations, each window may have its center axis on the respective stencil axis of the stencil layer, and the windows maybe considered coaxial to each other, such as first window 1867A, second window 1873A, and third window 1877A being coaxial to each other. In other implementations, at least one window may not be colinear with another window such that its center axis is offset from another window in a direction perpendicular to this stencil axis 1874. This positioning of the windows may be the same as the through-holes provided above.

In some implementations, all of the at least partially opaque portions may be the respective back surfaces of each transparent layer of material, like illustrated in FIG. 18. In some implementations, the at least partially opaque portion may be on a front surface of at least one layer of material. In some instances, all of the at least partially opaque portions may be the respective front surfaces of each transparent layer of material.

The stencil layers and at least partially opaque portions may have different colors, texturing, or both. Some colors include or black and the texturing may include physical texturing, like from sandblasting, or material within the layer like reflective or refractive materials, that are configured to reflect and/or refract light. These features may be configured to cause bright spots, similar to a sparkle effect.

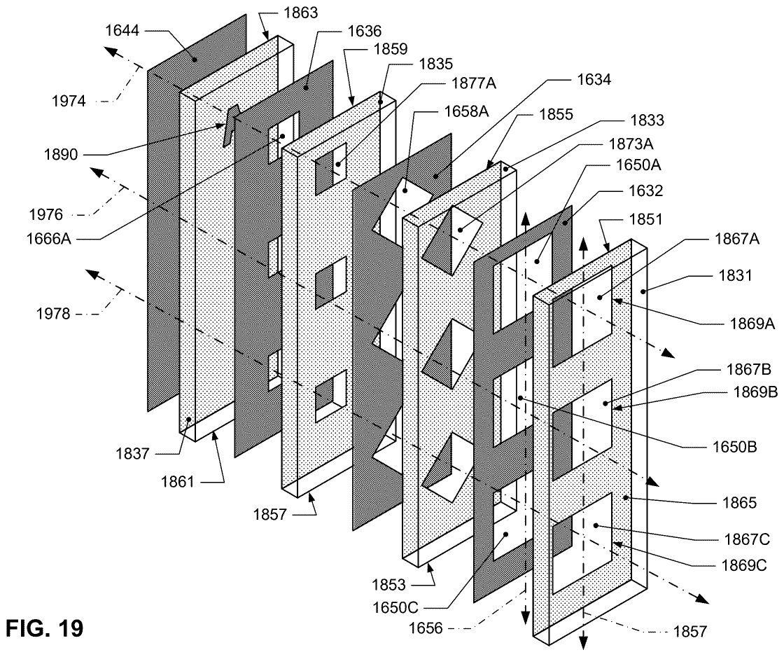

In some implementations, the assembly may have both have stencil layers and transparent layers of material with surfaces having at least partially opaque portions and windows corresponding to the through-holes of the stencil layers. This combination of features may provide various additional visual effects. For example, this may provide color and texture to the lighting surfaces. FIG. 19 depicts an off-angle exploded view of a portion of another layered stencil lightbox assembly. Here, the stencil layers 1632, 1634, and 1636 of FIGS. 16 and 17 are provided along with the transparent layers of material of FIG. 18 which each have a surface with a portion that is at least partially opaque and with a plurality of windows. For conciseness, not all features are repeated, but it shall be understood that these stencil layers 1632, 1634, and 1636 and transparent layers of material 1831, 1833, 1835, and 1837 have the same features provided above.

As can be seen in FIG. 19, the stencil layers 1632, 1634, and 1636 are interposed between the transparent layers of material 1831, 1833, 1835, and 1837, respectively, like illustrated in FIGS. 16 and 17. For example, the first stencil layer 1632 is interposed between the first and second transparent layers of material 1831 and 1833, the second stencil layer 1634 is interposed between the second and third transparent layers of material 1833 and 1835, and the third stencil layer 1636 is interposed between the third and fourth transparent layers of material 1835 and 1837. Each stencil layer 1632, 1634, and 1636 is comprised of an opaque material, is illustrated with dark shading, and has a plurality of through-holes, like provided above. For clarity, the through-holes of only the first stencil layer 1632 are labeled, with stencil layer 1632 having the through-holes 1650A-1650C arranged along the first axis 1656.

The transparent layers of material 1831, 1833, 1835, and 1837 are also illustrated and each of their back surfaces have a portion that is at least partially opaque, illustrated with light shading, and a plurality of windows. For instance, the first transparent layer of material 1831 has the first back surface 1851 with the at least partially opaque portion 1865 in light shading and the plurality of first windows 1867A-1867C arranged along the axis 1857. For clarity, not all the features of the transparent layers of material are labeled in FIG. 19. Like described above, the opaque, or semi-opaque, portion of the surface prevents or partially impedes a line of sight through the surface while each window provides a clear line of sight through the surface. For example, the plurality of first windows 1867A, 1867B, and 1867C each provide a line of sight to the stencil layers 1632, 1634, and 1636 and transparent layers of material 1833, 1835, and 1837.

The alignment of the through-holes of the stencil layers and the windows of layers of transparent material may be arranged like the through-holes are arranged with respect to adjacent stencil layers such that they may overlap with each other. This may include a window of one transparent layer at least partially overlapping a through-hole of an adjacent stencil layer, and at least partially overlapping with a window and through-hole of each of the other transparent layers of material and stencil layers, respectively. For example, each first window may at least partially overlap with a respective first through-hole, each first through-hole may at least partially overlap with a respective second window, and each second window may at least partially overlap with a corresponding second through-hole.

Referring to FIG. 19, the first window 1867A of the first transparent layer of material 1831 at least partially overlaps with the first through-hole 1650A of the first stencil layer 1632. This first window 1867A and first through-hole 1650A are also arranged along the first stencil axis 1974 that is perpendicular to the first axis 1656, the axis 1857, or both. The first through-hole 1650A of the first stencil layer 1632 also overlaps at least partially with the second window 1873A of the second transparent layer of material 1833. The second window 1873A at least partially overlaps with the through-hole 1658A of the second stencil layer 1634, and the through-hole 1658A at least partially overlaps with the third window 1877A of the third transparent layer of material 1833. The third window 1877A partially overlaps with the through-hole 1666A of the third stencil layer 1636, and the through-hole 1666A at least partially overlaps with the window having a shape 1890. These windows and through-holes are also arranged along the same stencil axis 1974.

The other windows and through-holes are similarly arranged. For instance, another first window 1867B partially overlaps with another through-hole 1650B, and these features are arranged along the same axis 1976 that is perpendicular to axis 1656, 1857, or both. Yet another first window 1867C at least partially overlaps with another through-hole 1650C, and these features are arranged along the same axis 1978 that is perpendicular to axis 1656, 1857, or both.

In some implementations, the boundary of a window may be the same shape and size as the through-hole of the adjacent stencil layer. In FIG. 19, the first window boundary 1869A of a first window 1867A may have the same shape and size as the through-hole 1650A of the adjacent stencil layer 1632, for example. In this example, the first window boundary 1869A and the through-hole 1650A are both squares. Put another way, the area of the first window 1867A, defined by the first boundary 1669A, may be the same as the area of the through-hole 1650A of the first stencil layer 1632 immediately adjacent to the transparent layer of material 1831, which may be immediately adjacent to the first back surface 1851. Similarly, the second window 1873A of the second transparent layer 1833 has the same shape, size, and orientation as the through-hole 1658A of the immediately adjacent second stencil layer 1634.

For the systems with layers comprising transparent, or semi-transparent, material, each plurality of LEDs may be configured to illuminate a respective transparent layer of material. This may include positioning a plurality of LEDs proximate or adjacent to an edge or side of transparent layer of material. In some such instances, the transparent layers of material may be positioned in direct contact with each other without a gap therebetween. In some instances that also have stencil layers, like in FIG. 19, each stencil layer may be in direct contact with at least one adjacent transparent layer of material.

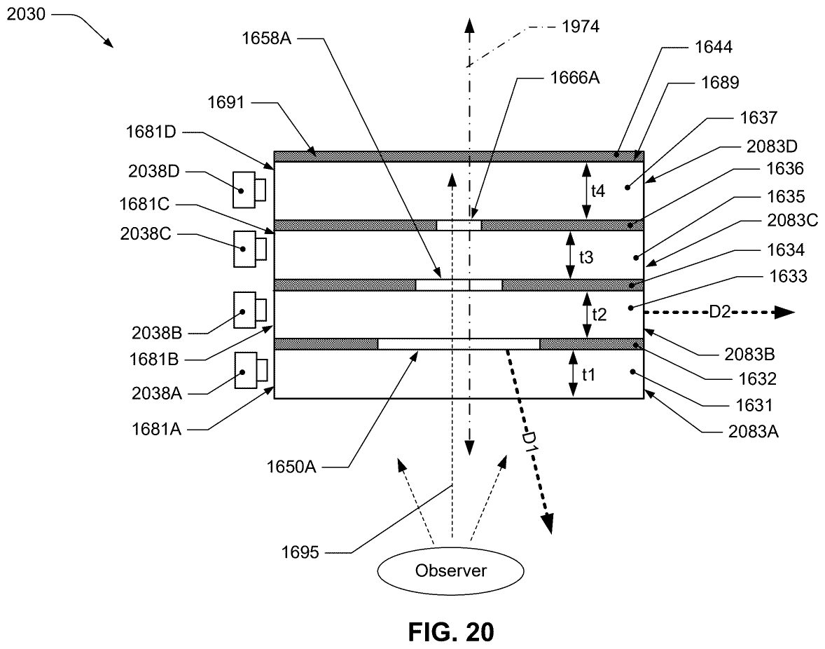

FIG. 20 depicts a cross-sectional top view of the system of FIG. 16. Here, the stencil layers 1632, 1634, 1636, and 1644 of FIG. 16 are shown along the four transparent layers of material 1631, 1633, 1635, and 1637, and with four pluralities of LEDs 2038A-2038D. This view is perpendicular to a plane intersecting a plurality of through-holes, such as a plane intersecting stencil axis 1974 and perpendicular to axis 1656. The observer has a line of sight 1695 through the first transparent layer of material 1631 which may be the front most layer of the assembly. The line of sight continues through the thickness t1 of the transparent layer of material 1631 to the first stencil layer 1632 which prevents a line of sight through the stencil layer 1632 except at each through-hole, such as through-hole 1650A.

Similarly, the second transparent layer of material 1633 provides a line of sight from the through-hole 1650A of the first stencil layer 1632 through its thickness t2 to the second stencil layer 1634. The second stencil layer 1634 prevents a line of sight except at each through-hole, such as through-hole 1658A. The third transparent layer of material 1635 provides a line of sight from the through-hole 1658A through its thickness t3 to the third stencil layer 1636. The third stencil layer 1636 prevents a line of sight except at each through-hole, such as through-hole 1666A. The line of sight continues through the thickness t4 of the fourth transparent layer of material 1637 to the back stencil layer 1644.

The pluralities of LEDs are configured to emit light into, and thereby illuminate, each transparent layer of material. As further illustrated in FIG. 20, the first plurality of LEDs 2038A is positioned adjacent to a first edge 1681A of the first transparent layer of material 1631 and configured to emit light into the first transparent layer of material 1631. The second plurality of LEDs 2038B is positioned adjacent to a first edge 1681B of the second transparent layer of material 1633 and configured to emit light into the second transparent layer of material 1633. The third plurality of LEDs 2038C is positioned adjacent to a first edge 1681C of the third transparent layer of material 1635 and configured to emit light into the third transparent layer of material 1635. The fourth plurality of LEDs 2038D is positioned adjacent to a first edge 1681D of the fourth transparent layer of material 1637 and configured to emit light into the fourth transparent layer of material 1637.

The adjacent opaque stencil layers material may be configured to confine light emitted within the transparent layer of material to within that transparent layer of material, except for the through-holes. For instance, the first and second stencil layers 1634 and 1632 confine the light emitted by the second plurality of LEDs 2038B into second transparent layer of material 1633. This light may exit the second transparent layer of material 1633 at through-holes 1650A and 1658A. This illumination may provide various visual effects of the shapes defined by the through-holes. These effects may be similar to those illustrated in FIGS. 9A-9D. For example, in FIG. 9B, it may be considered that the second plurality of LEDs 2038B are emitting light into the second transparent layer of material 1633 which illuminates light within through-holes, which here are labeled through holes 450A-450C. The shading illustrates the areas that may be illuminated by these LEDs.

In some implementations, the sides of each transparent layer of material opposite the pluralities of LEDs may be covered by a cover, like provided above. This may prevent the light from escaping out the edges or sides of the transparent layers of material.

In other implementations, it may be advantageous to have the light within the transparent layers of material exit out the sides and thereby provide another illumination surface of the system. For example, the light emitted inside the transparent layer of material 1631, 1633, 1635, and 1637 of FIG. 20 may exit out of the through-holes and in a direction towards the observer. This may be considered a first illumination direction D1 of the system. By having the same light exit the sides 2083A-2083D of the transparent layers of material 1631, 1633, 1635, and 1637, respectively, opposite the LEDs, light may be emitted in a second, different direction D2. In some implementations, these sides 2083A-2083D may have texturing, coating, or other features configured to diffuse, reflect, refract, or soften the light emitted therefrom. This may include frosting or a semitransparent coating.

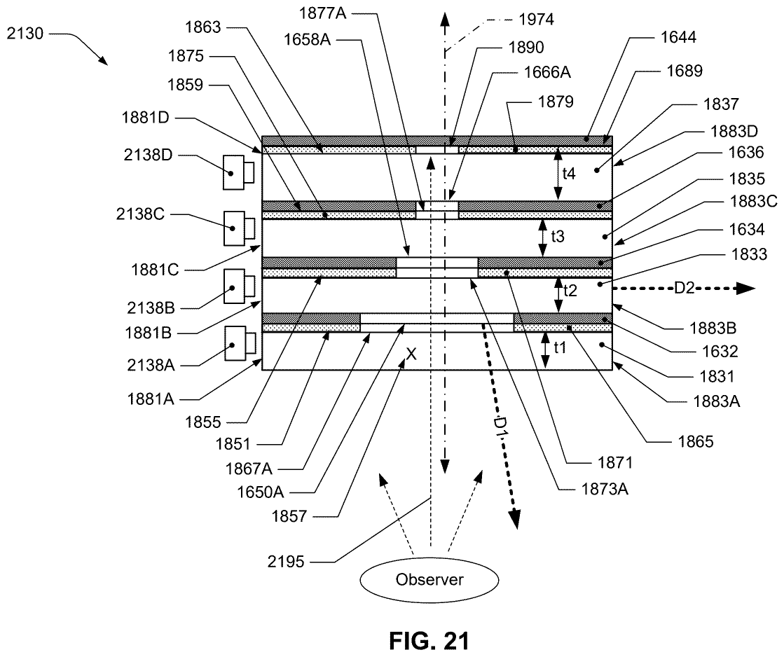

Similar to FIG. 20, the assembly having the stencil layers and transparent layers of material with surfaces having opaque portions and windows may provide various lines of sight and illumination. FIG. 21 depicts a cross-sectional top view of the system of FIG. 19. Here, the stencil layers 1632, 1634, 1636, and 1644 of FIG. 16 are shown along the four transparent layers of material 1831, 1833, 1835, and 1837 with back surfaces having an opaque portion and windows, and with four pluralities of LEDs 2138A-2138D. This view is perpendicular to a plane intersecting a plurality of through-holes, such as a plane intersecting stencil axis 1974 and perpendicular to axis 1857 which is perpendicular to the page and indicated as an “X”. The observer has a line of sight 2195 through the first transparent layer of material 1831 which may be the front most layer of the assembly. The line of sight continues through the thickness t1 of the transparent layer of material 1631 to its first back surface 1851 which has the at least partially opaque portion 1865 and the first window 1867A. The at least partially opaque portion 1865 may block or obscure the line of sight through the first back surface 1851 of the first transparent layer of material 1831. For instance, this at least partially opaque portion 1865 may be texturing that reflects and refracts light that obfuscates the line of sight, but does not block it. The first window 1867A provides a line of sight through the first back surface 1851 to the first stencil layer 1632, including the first through-hole 1650A. This first through-hole 1650A provides a line of sight to the adjacent second transparent layer of material 1833.

The line of sight continues through the thickness t2 of the second transparent layer of material 1633 to its second back surface 1855 which has the at least partially opaque portion 1871 and the second window 1873A. The at least partially opaque portion 1871 may block or obscure the line of sight through the second back surface 1855. The second window 1873A provides a line of sight to the second stencil layer 1634 and its second through-hole 1658A. This second through-hole 1658A provides the line of sight to the next, adjacent second transparent layer of material 1835. The line of sight continues through the thickness t3 of the second transparent layer of material 1635 to its third back surface 1859 which has the at least partially opaque portion 1875 and the third window 1877A. The opaque or semi-opaque portion 1875 may block or obscure the line of sight through the third back surface 1859. The third window 1877A provides a line of sight to the third stencil layer 1636 and its third through-hole 1666A, and this third through-hole 1666A provides the line of sight to the adjacent fourth transparent layer of material 1837.

The line of sight continues through the thickness t4 of the fourth transparent layer of material 1637 to its fourth back surface 1863 which has the at least partially opaque portion 1879 and the fourth window 1890 which may have a shape, like the letter “A”. The opaque or semi-opaque portion 1879 may block or obscure the line of sight through the fourth back surface 1863. The fourth window 1890 provides a line of sight to the back stencil layer 1644.

The arrangement of the through-holes and windows of the various layers is also illustrated in FIGS. 20 and 21. For example, the first window 1867A at least partially overlaps with the first through-hole 1650A, and both these features are arranged along the first stencil axis 1974. Similarly, the first through-hole 1650A at least partially overlaps with the second window 1873A, and the second window 1873A at least partially overlaps with the second through-hole 1658A. The second window 1873A and the second through-hole 1658A are also arranged along the same stencil axis 1974. Further, the second through-hole 1658A at least partially overlaps with the third window 1877A, and the third window 1877A at least partially overlaps with the third through-hole 1666A.

Like with FIG. 20, in FIG. 21 the pluralities of LEDs are configured to emit light into, and thereby illuminate, each transparent layer of material. The first plurality of LEDs 2138A is positioned adjacent to a first edge 1881A of the first transparent layer of material 1831 and configured to emit light into the first transparent layer of material 1831. The second plurality of LEDs 2138B is positioned adjacent to a first edge 1881B of the second transparent layer of material 1833 and configured to emit light into the second transparent layer of material 1833. The third plurality of LEDs 2138C is positioned adjacent to a first edge 1881C of the third transparent layer of material 1835 and configured to emit light into the third transparent layer of material 1835. The fourth plurality of LEDs 2138D is positioned adjacent to a first edge 1881D of the fourth transparent layer of material 1837 and configured to emit light into the fourth transparent layer of material 1837.

The adjacent at least partially portions of the transparent layers of material and the opaque stencil layers may be configured to reflect refract light emitted within the transparent layer of material, and to confine that light to within that transparent layer of material, except for the through-holes and windows. For instance, the first and second stencil layers 1634 and 1632 confine the light emitted by the second plurality of LEDs 2138B into second transparent layer of material 1833, and the opaque or semi-opaque portion 1871 may reflect and refract the light within the transparent layer of material 1833. This light may exit the second transparent layer of material 1833 at first and second windows 1867A and 1873A, respectively, and first and second through-holes 1650A and 1658A, respectively. This illumination may provide various visual effects of the shapes defined by the windows and through-holes. These effects may be similar to those illustrated in FIGS. 9A-9D.

In some implementations, like above, the sides of each transparent layer of material opposite the pluralities of LEDs may be covered by a cover, like provided above. This may prevent the light from escaping out the edges or sides of the transparent layers of material. In other implementations, it may be advantageous to have the light within the transparent layer of material exit out the sides and thereby provide another illumination surface of the system. For example, the light emitted inside the transparent layers of material 1831, 1833, 1835, and 1837 of FIG. 21 may exit out of the windows and through-holes and in a direction towards the observer. This may be considered a first illumination direction D1 of the system. By having the same light exit the sides 1883A-1883D of the transparent layers of material 1831, 1833, 1835, and 1837, respectively, opposite the LEDs, light may be emitted in a second, different direction D2. In some implementations, these sides 1883A-1883D may have texturing, coating, or other features configured to diffuse, reflect, refract, or soften the light emitted therefrom. This may include frosting or a semitransparent coating.

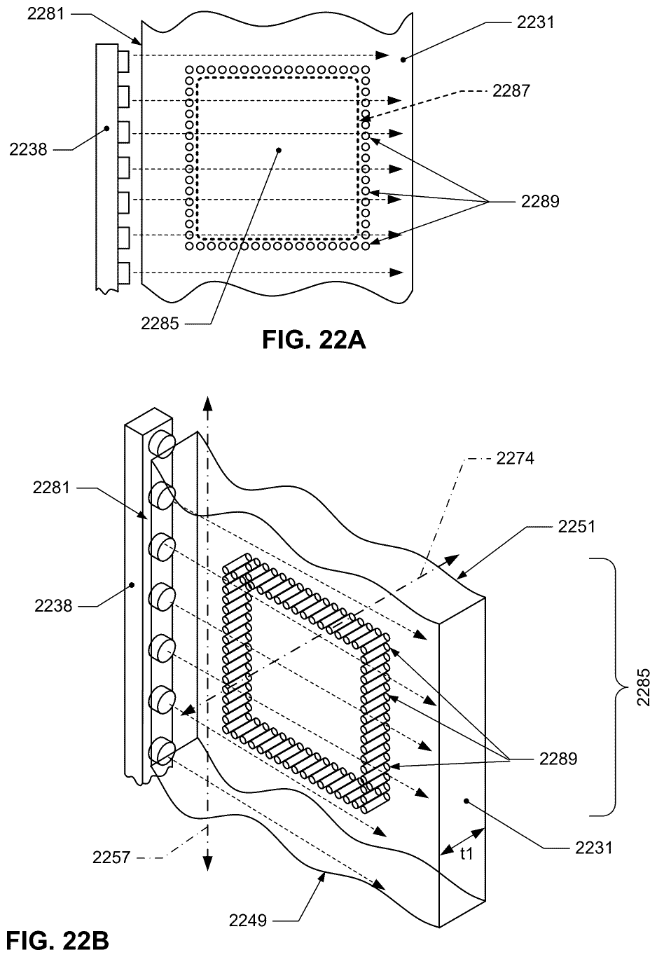

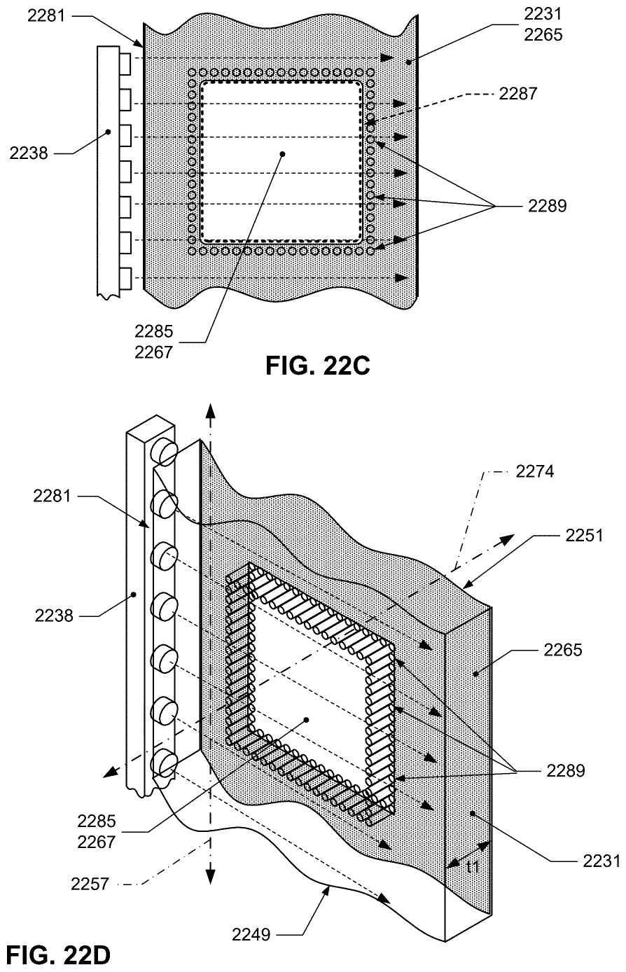

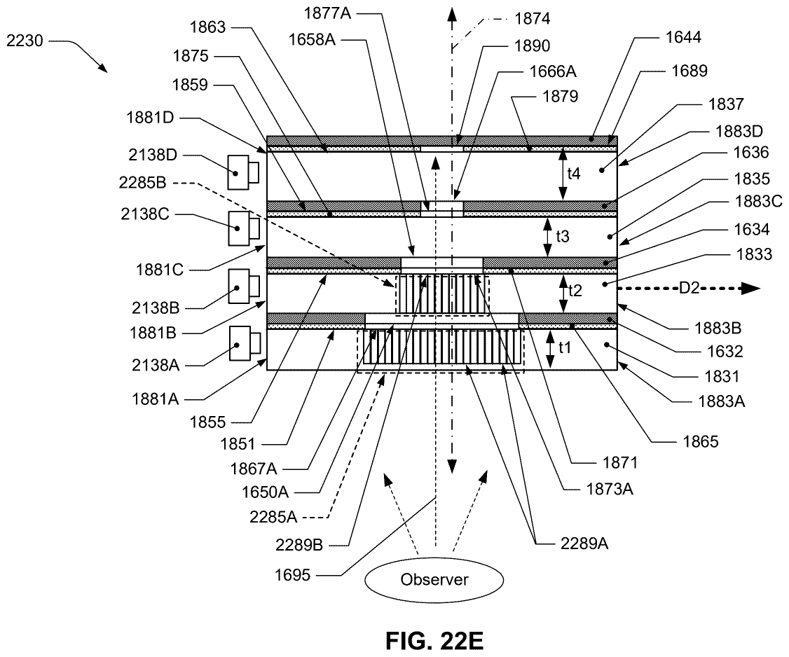

In some implementations, a transparent layer of material may have another plurality of windows that are defined by a boundary and one or more features extending along the boundary and extending at least partially through the thickness of the transparent layer of material. For example, the one or more features may be a plurality of holes or channels that are arranged along the boundary, and this plurality of holes may define the shape of the second window. FIG. 22A depicts a plan view of a portion of a transparent layer of material having a window defined by one or more features, which here is a plurality of holes. In this example, this transparent layer of material 2231 may be comprised of a transparent or semitransparent material. A window 2285 having a square shape is depicted and it is encircled and defined by a dashed boundary 2287. A plurality of holes 2289 extends around the window 2285, extends along the boundary 2287, and defines the window 2285. For clarity, the boundary 2287 is illustrated as a dashed line inwards of the holes 2289 even though the plurality of holes 2289 extends along the boundary 2287. The area within the boundary 2287, or within the holes 2289, may be considered the window 2285.

The plurality of features may extend through at least a portion of the thickness of the transparent layer of material in a direction having a component perpendicular to the first axis. FIG. 22B depicts an off-angle view of the portion of the transparent layer of material of FIG. 22A. A front surface 2249 and the back surface 2251 are indicated, and the holes 2289 defining the window 2285 span at least partially between the front surface 2249 and the back surface 2251, which may be considered to extend partially through the thickness t1 of the transparent layer of material 2231. These holes 2289 also extend in a direction perpendicular to the first axis 2257, which may be parallel to the stencil axis 2274. In this example, the holes 2289 are also partial through-holes that extend only a part of the way through the thickness t1 of the transparent layer of material 2231. In some other instances, the features may extend fully through the thickness t1 from the front surface 2249 to the back surface 2251.

The features defining this other window in the transparent layer of material may be configured to be illuminated by the pluralities of LEDs and form an illuminated boundary or outline of the window. For instance, in FIGS. 22A and 22B, a portion of a plurality of LEDs 2238 is positioned adjacent to the first edge 2281 of the transparent layer of material 2231 and configured to emit light into the transparent layer of material 2231 between the first and second surfaces 2249 and 2251. The transparent layer of material 2231 may be transparent and the plurality of holes 2289 may create texturing or other surfaces that catch, reflect, and refract the emitted light. In some instances, the light emitted into the transparent layer of material 2231 is only visible at the surfaces of the features defining the window 2285, such as the holes 2289 in this example. The emitted light is illustrated here with dashed arrows.

These features defining the other windows in the transparent layers of material may take other forms or shapes, and may follow differently shapes boundaries. For example, these features may be a channel or groove that extends partially through the stencil layer thickness and follows a boundary having a shape. As provided above, the boundary of these windows may take any shape, such as geometric shapes, like squares, rectangles, circles, triangles, obrounds, ellipses, trapezoids, hexagons, pentagons, octagons, etc., to letters, numbers, words, and individual images like animals (e.g., buffalos, dragons, tigers), sports shapes (e.g., soccer balls, footballs, basketballs), other items that may be related to a game theme for an electronic gaming machine, like a pot of gold, fireworks, coins, money, etc.

In some implementations, the other window and its plurality of features may at least partially overlap with the window of the surface of the transparent layer of material partially defined by the at least partially opaque portion on the surface, and the through-hole of an adjacent stencil layer. For example, FIG. 22C depicts another configuration of FIG. 22A, and FIG. 22D depicts another configuration of FIG. 22B. Here, the transparent layer of material 2231 may be considered to have a back surface with the at least partially opaque portion 2265 and a first window 2267. As can be seen, the first window 2267 and the second window 2285 at least partially overlap with each other. The plurality of holes 2289 extends around the second window 2285 and in some instances, like here, it may encircle and extend around the first window 2267. In some other instances, the first window 2267 may encircle and extend around the plurality of holes 2289 and the second window 2285. This configuration of FIGS. 22C and 22D may prevent or reduce visibility through the back surface 2251 outside the holes 2289 and provide visibility through the portion within the holes 2289.

Similar to above, each other window may be arranged along a corresponding, respective stencil axis, such as stencil axis 1874 in FIGS. 18 and 19. For example, the first transparent layer of material 1831 may have a second window having a plurality of features, like holes extending around and defining the boundary of the second window, and this second window may be positioned along stencil axis 1874 of FIG. 19. This second window may at least partially overlap the first window 1867A and the through-hole 1650A. Similarly, the second transparent layer of material 1833 may have another second window positioned along the stencil axis 1874 of FIG. 19 such that it least partially overlaps the window 1873A and the through-hole 1658A. Referring back to FIGS. 22B and 22D, a representative stencil axis 2274 is also provided to indicate this arrangement of the second window 2285. Here, the second window 2285 and the first window 2267 are arranged along the stencil axis 2274 which his perpendicular to the first axis 2257.

FIG. 22E depicts the assembly of FIG. 21 in another configuration. Here, the first transparent layer of material 1831 has a second window 2285A defined by the plurality of holes 2289A that are depicted as holes extending partially through the thickness t1 of the first transparent layer of material 1831. As can be seen, this second window 2285A is arranged along the stencil axis 1874 and at least partially overlaps with the first window 1867A and the first through-hole 1650A of the first stencil layer 1632. Also, the second transparent layer of material 1833 has another second window 2285B defined by another plurality of holes 2289B. These holes 2289B may extend fully through the second transparent layer of material 2233. As can be seen, this other second window 2285B is arranged along the stencil axis 1874 and at least partially overlaps with the window 1873A and the through-hole 1658A of the second stencil layer 1634.

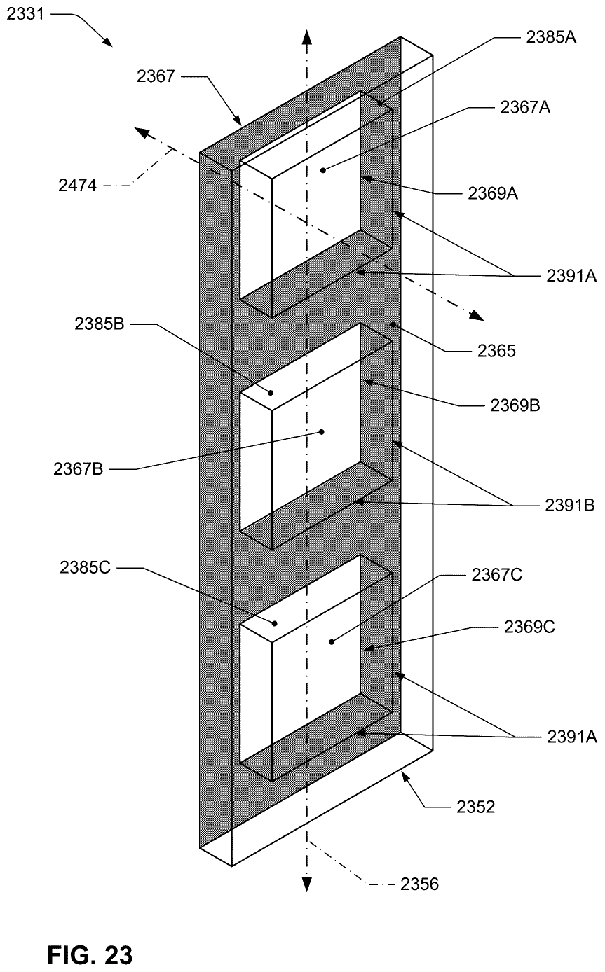

FIG. 23 depicts an off-angle view of another transparent layer of material. Here, the transparent layer of material 2331 has a back surface 2351 with an at least partially opaque portion 2365 and a plurality of windows 2367A, 2367B, and 2367C, defined by boundaries, 2369A, 2369B, and 2369C, respectively. These windows 2367A-2367C are arranged along the axis 2356. In this example, the transparent layer of material 2331 also has second windows 2385A, 2385B, and 2385C defined by the one or more features that extend through at least a portion of the thickness t1 of the transparent layer of material 2331. These features 2391A, 2391B, and 2391C correspond with the second windows 2385A, 2385B, and 2385C, and also with windows 2367A, 2367B, and 2367C, respectively. For example, features 2391A correspond with window 2367A and second window 2385A, features 2391B correspond with window 2367B and second window 2385B, and features 2391C correspond with window 2367C and second window 2385C. These features 2391A, 2391B, and 2391C are represented here as lines to indicate their location, and they may be considered to have various shapes and configurations, such as the plurality of holes illustrated in FIGS. 22A and 22B, as well as grooves, slots, or other partial through holes. In some instances, these features 2391A, 2391B, and 2391C may follow a boundary that is the same as the boundary 2369A-2369C, respectfully, of the windows 2367A-2369C, respectively.

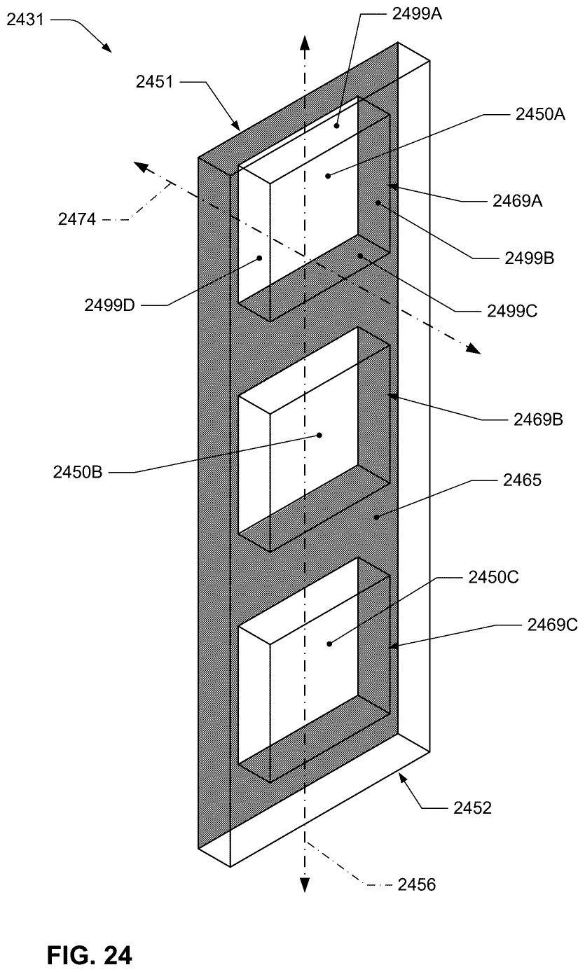

In some implementations, the transparent layers of material may also have a plurality of through-holes that extend fully or partially through the stencil layer like through-holes 450A-450C provided above. The internal surfaces of each partial through-hole or full through-hole may have various configurations, such as smooth, texturing such as sanding, or various shapes like waves, sawtooth patterns, semicircles, or the like. FIG. 24 depicts an off-angle view of yet another transparent layer of material. Here, the transparent layer of material 2431 is transparent, or semitransparent, and has a back surface 2451 with an opaque or semi-opaque portion 2465. In this example, the transparent layer of material 2431 has a plurality of through-holes, like described above with respect to the stencil layers, that extend fully or partially through the transparent layer of material 2431. Each of these holes has an outer boundary 2469A, 2469B, and 2469C, respectively, with one or more surfaces facing the hole. Each of these surfaces, such as surfaces 2499A-2499D that define the through-hole 2450A, may be without any texturing while in some instances they may have texturing or shapes, like semicircles, triangular sawtooth, square sawtooth, waves, triangular, or a combination thereof. In some implementations, the through-holes 2450A-2450C extend fully through the layer of transparent material 2431.

In some implementations, the through-holes 2450A-2450C extend partially through the transparent layer of material 2431. In some of these instances, the through-holes 2450A-2450C extend through the back surface 2451 and may form the windows providing a line of sight through the back surface 2451. In some other instances, the through-holes 2450A-2450C extend through the front surface 2452 and do not intersect with the back surface 2451. The back surface may therefore have the windows that are aligned with the through-holes in this transparent layer of material 2431. This alignment is provided herein above, such as at least partially overlapping with each other along a stencil axis.

Any of the above systems and assemblies with transparent layers of materials may be curved as provided herein. This includes, for example, being curved as shown in FIGS. 13-15. In a specific example, referring to FIG. 14, a transparent layer of material may be curved like stencil layers 1432 and 1434 and positioned in between these two curved stencil layers. For transparent layers of material having windows as provided above, these windows may also be curved and arranged such that they at least partially overlap with the curved through-holes, such as 1450A and 1458A.

When an element, such as a layer, is referred to as being “on,” “connected to,” or “coupled to” another element, it may be directly on, directly connected to, or directly coupled to the other element or at least one intervening element may be present. When, however, an element is referred to as being “directly on,” “directly connected to,” or “directly coupled to” another element, there are no intervening elements present. Other terms and/or phrases if used herein to describe a relationship between elements should be interpreted in a like fashion, such as “between” versus “directly between,” “adjacent” versus “directly adjacent,” “on” versus “directly on,” etc. Further, the term “connected” may refer to physical, electrical, and/or fluid connection.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items.

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A layered stencil lightbox system, comprising:
a first stencil layer arranged along a first axis and having a first front surface, a first back surface offset from the first front surface, and a plurality of first through-holes extending from the first front surface to the first back surface and arrayed along the first axis;
a second stencil layer arranged along a second axis parallel to the first axis, and having a second front surface, a second back surface offset from the second front surface, and a plurality of second through-holes extending from the second front surface to the second back surface and arrayed along the second axis;
a third stencil layer arranged along a third axis parallel to the first axis, and having a third front surface that faces the second back surface of the second stencil layer, and a third back surface offset from the third front surface;
a first plurality of light emitting diodes (LEDs) positioned proximate to a first edge of the first stencil layer and a second edge of the second stencil layer, and configured to emit light between the first stencil layer and the second stencil layer; and
a second plurality of LEDs positioned proximate to the second edge of the second stencil layer, and configured to emit light between the second stencil layer and the third stencil layer, wherein:
the second stencil layer is:
positioned between the first stencil layer and the third stencil layer such that the second front surface faces the first back surface of the first stencil layer, and the second back surface faces the third front surface of the third stencil layer, and
offset from the first stencil layer and the third stencil layer in a direction perpendicular to the first axis, and
each first through-hole at least partially overlaps each respective second through-hole.

2. The system of claim 1, further comprising:
a first transparent layer of material interposed between the first stencil layer and the second stencil layer; and
a second transparent layer of material interposed between the second stencil layer and the third stencil layer, wherein:
the first plurality of LEDs are arranged adjacent to a first edge of the first transparent layer of material and configured to emit light into the first transparent layer of material, and
the second plurality of LEDs are arranged adjacent to a first edge of the second transparent layer of material and configured to emit light into the first transparent layer of material.

3. The system of claim 2, wherein:
the first transparent layer of material has a first back surface with a first portion that is at least partially opaque and with a plurality of first windows that each provide a line of sight through the first back surface,
the second transparent layer of material has a second back surface with a second portion that is at least partially opaque and with a plurality of second windows that each provide a line of sight through the second back surface,
each first window at least partially overlaps with a respective first through-hole,
each first through-hole at least partially overlaps with a respective second window, and
each second window at least partially overlaps with a respective second through-hole.

4. The system of claim 3, wherein the first portion and the second portion comprise texturing.

5. The system of claim 3, wherein each first through-hole and a respective first window, respective second through-hole, and respective second window are arranged along a respective stencil axis perpendicular to the first axis.

6. The system of claim 2, wherein:
the first transparent layer of material has a third window defined by a third boundary and one or more third features extending along the third boundary and extending at least partially through a thickness of the first transparent layer of material, and
the second transparent layer of material has a fourth window defined by a fourth boundary and one or more fourth features extending along the fourth boundary and extending at least partially through a thickness of the second transparent layer of material.

7. The system of claim 6, wherein:
the one or more third features are a plurality of holes or one or more channels, and
the one or more fourth features are a plurality of holes or one or more channels.

8. The system of claim 3, wherein:
the first stencil layer is coupled to the first transparent layer of material, and
the second stencil layer is coupled to the second transparent layer of material.

9. The system of claim 1, wherein:
each first through-hole has a first area, and
each second through-hole has a second area that is smaller than the first area.

10. The system of claim 1, wherein:
each first through-hole defines a first shape, and
each second through-hole defines a second shape that is different than the first shape and smaller than the first shape.

11. The system of claim 1, wherein:
each first through-hole defines a first shape, and
each second through-hole defines a second shape that is oriented at an angular offset from the first shape.

12. The system of claim 1, further comprising:
a fourth stencil layer arranged along a fourth axis parallel to the first axis, and having a fourth front surface and a fourth back surface offset from the fourth front surface; and
a third plurality of LEDs positioned proximate to a third edge of the third stencil layer and configured to emit light between the third stencil layer and the fourth stencil layer, wherein:
the third stencil layer further comprises a plurality of third through-holes extending from the third front surface to the third back surface and arrayed along the third axis,
the third stencil layer is:
positioned between the second stencil layer and the fourth stencil layer such that the third front surface faces the second back surface of the second stencil layer, and the third back surface faces the fourth front surface of the fourth stencil layer, and
offset from the second stencil layer and the fourth stencil layer in the direction perpendicular to the first axis,
each first through-hole at least partially overlaps each respective third through-hole, and
each second through-hole at least partially overlaps each respective third through-hole.

13. The system of claim 12, wherein:
each first through-hole has a first area,
each second through-hole has a second area that is smaller than the first area, and
each third through-hole has a third area that is smaller than the second area.

14. The system of claim 1, wherein:
the first plurality of LEDs is positioned outside a first gap between the first stencil layer and the second stencil layer, and
the second plurality of LEDs is positioned outside a second gap between the second stencil layer and the third stencil layer.

15. The system of claim 1, wherein:
the third stencil layer is without through-holes and has a plurality of shapes in a surface of the third stencil layer that are arrayed along the third axis,
each first through-hole at least partially overlaps each respective shape, and
each second through-hole at least partially overlaps each shape.

16. The system of claim 1, further comprising:
a first sidewall adjacent to the first edge of the first stencil layer, the second edge of the second stencil layer, and the third stencil layer; and
a second sidewall adjacent to a third edge of the first stencil layer opposite the first edge, a fourth edge of the second stencil layer opposite the second edge, and the third stencil layer, wherein:
the first plurality of LEDs and the second plurality of LEDs are coupled to the first sidewall, and
the first stencil layer and the second stencil layer are interposed between the first sidewall and the second sidewall.

17. The system of claim 1, wherein the first axis, the second axis, and the third axis are linear.

18. The system of claim 1, wherein:
the first axis, the second axis, and the third axis are nonlinear, and
the first stencil layer, the second stencil layer, and the third stencil layer are nonplanar or planar.

19. An electronic gaming machine, comprising:
a cabinet defining an internal compartment;
one or more display devices connected to the cabinet; and
a layered stencil lightbox system positioned on the cabinet and having:
a first stencil layer arranged along a first axis and having a first front surface, a first back surface offset from the first front surface, and a plurality of first through-holes extending from the first front surface to the first back surface and arrayed along the first axis,
a second stencil layer arranged along a second axis parallel to the first axis, and having a second front surface, a second back surface offset from the second front surface, and a plurality of second through-holes extending from the second front surface to the second back surface and arrayed along the second axis,
a third stencil layer arranged along a third axis parallel to the first axis, and having a third front surface that faces the second back surface of the second stencil layer, and a third back surface offset from the third front surface,
a first plurality of light emitting diodes (LEDs) positioned proximate to a first edge of the first stencil layer and a second edge of the second stencil layer, and configured to emit light between the first stencil layer and the second stencil layer, and
a second plurality of LEDs positioned proximate to the second edge of the second stencil layer, and configured to emit light between the second stencil layer and the third stencil layer, wherein:
the second stencil layer is:
positioned between the first stencil layer and the third stencil layer such that the second front surface faces the first back surface of the first stencil layer, and the second back surface faces the third front surface of the third stencil layer, and
offset from the first stencil layer and the third stencil layer in a direction perpendicular to the first axis, and
each first through-hole at least partially overlaps each respective second through-hole.

20. A method, comprising:
emitting light, with a first plurality of light emitting diodes (LEDs), in a first gap between a first stencil layer and a second stencil layer, wherein the first stencil layer is arranged along a first axis and has a first front surface, a first back surface offset from the first front surface, and a plurality of first through-holes extending from the first front surface to the first back surface and arrayed along the first axis, wherein the second stencil layer is arranged along a second axis parallel to the first axis, and has a second front surface, a second back surface offset from the second front surface, and a plurality of second through-holes extending from the second front surface to the second back surface and arrayed along the second axis, wherein the first plurality of LEDs is positioned proximate to a first edge of the first stencil layer and a second edge of the second stencil layer, and configured to emit light between the first stencil layer and the second stencil layer; and
emitting light, with a second plurality of LEDs, in a second gap between the second stencil layer and a third stencil layer while the first plurality of LEDs are not illuminating the first gap, wherein the third stencil layer is arranged along a third axis parallel to the first axis, and having a third front surface that faces the second back surface of the second stencil layer, and a third back surface offset from the third front surface, wherein the second stencil layer is positioned between the first stencil layer and the third stencil layer such that the second front surface faces the first back surface of the first stencil layer, and the second back surface faces the third front surface of the third stencil layer, and offset from the first stencil layer and the third stencil layer in a direction perpendicular to the first axis, wherein each first through-hole at least partially overlaps each respective second through-hole, and wherein the second plurality of LEDs is positioned proximate to the second edge of the second stencil layer, and configured to emit light between the second stencil layer and the third stencil layer.
